(19) United States
(12) Patent Application Publication
(10) Pub. No.: US 2009/0220750 A1
(43) Pub. Date: Sep. 3, 2009

(54) Partial Printing Of A Substrate Using Metallization

(75) Inventors: G. Roland Hill, Cheshire (GB); Andrew James Voss, Maidenhead (GB)

Correspondence Address: PILLSBURY WINTHROP SHAW PITTMAN, LLP, P.O. BOX 10500, MCLEAN, VA, 22102, US

(73) Assignee: Contra Vision Limited, Bramhall, Cheshire (GB)

(21) Appl. No.: 12/280,575

(22) PCT Filed: Feb. 28, 2007
(86) PCT No.: PCT/IB2007/002324

§ 371 Date: Sep. 22, 2008

Related U.S. Application Data
(60) Provisional application No. 60/776,932, filed on Feb. 28, 2006.

(51) Int. Cl. B32B 3/10; B44C 1/22

(52) U.S. Cl. 428/195.1; 216/41; 216/45; 216/52

(57) ABSTRACT

A panel includes a light permeable material that is partially coated with superimposed layers and includes a metallized layer. A print pattern typically has a radiation-reflective surface facing one side of the panel and a radiation-absorbing surface facing the other side of the panel, for example to form a vision control panel, for example a one-way vision, see-through graphic panel.

### CROSS-REFERENCE TO RELATED APPLICATIONS

This application claims the benefit of priority from U.S. Provisional Patent Application Ser. No. 60/776,932, titled “Partial Printing of a Substrate Using Metallization,” filed Feb. 28, 2006, the entire contents of which are incorporated by reference herein.

### BACKGROUND TO THE INVENTION

1. Field of the Invention

This invention relates to one-way and other vision control panels and methods of printing such panels.

2. Description of Related Art

One-way and other vision control panels are described in GB 2 118 096 and US RE 37,186, which reissued from U.S. Pat. No. 4,673,609. GB 2 118 096 discloses a transparent plastic substrate partially covered with a pattern of one color when viewed from one side, for example white, and another color when viewed from the other side, typically black.

Depending partly upon conditions of illumination, through vision is typically totally or partially obscured from the white side, the black side providing good through vision. One-way vision, see-through graphic panels are described in US RE37,186. Such panels typically comprise a sheet of transparent or translucent material and a design formed on the sheet, the design being visible from one side of the panel and not visible from the other side of the panel, the design being superimposed on or forming part of an opaque “silhouette pattern”, which divides the panel into a plurality of discrete opaque areas and/or a plurality of discrete transparent or translucent areas. US RE37,186 includes eight methods of making such panels, including a resist method, in which layers of marking material are superimposed on a transparent or translucent light permeable material, followed by a resist layer in the form of the “silhouette pattern”, followed by an etching process. In this method, the marking material is typically screen-printed ink. In order to achieve the required opacity of the “silhouette pattern” by screen-printing, the layers of ink are relatively thick and the overall thickness of ink varies significantly because the layers of ink forming the design are applied to discrete areas of the substrate. This variable thickness of relatively thick ink layers exacerbates “under-etch” and “over-etch”, which are known problems with any resist and etch method. Problems of under-etch and over-etch are further exacerbated in products according to US RE37,186, which typically have a silhouette pattern comprising opaque areas of width typically not exceeding 2 mm. The edges of layers revealed by under-etch or over-etch from either side comprise a higher proportion of the area of elements of such small size than elements of relatively large size. Unwanted exposed color at the edges can cause the desired perceived color to be substantially amended. This method has an additional disadvantage when using solvent inks that obtain their bond partly or totally through an etching action into a transparent substrate. When this ink is removed, the surface is no longer plane but has a surface topography which may be sufficiently pitted to cause optical distortion, preventing proper focusing upon an object on the other side of the transparent substrate.

US RE37;186 and U.S. Pat. No. 4,925,705 disclose “stencil” methods of partially printing panels by means of a stencil layer of the required “silhouette pattern” or “print pattern”, followed by layers of ink and the removal of unwanted ink by high pressure water hosing or the application and removal of an adhesive layer, to leave superimposed layers of ink in substantially exact registration within the desired pattern. These patents also disclose “direct” methods of printing with substantially exact registration, in which a first layer in the form of the desired pattern is printed directly onto the substrate, followed by a second layer that adheres well to the first layer but not the substrate, any subsequent layers adhering well to the second layer. Unwanted ink is then removed as in the stencil method to leave superimposed layers of ink in substantially exact registration within the desired pattern.

There are known problems of solvent migration from one ink layer to other ink layers, which affects the efficiency of these resist, direct and stencil processes including, for example, making it difficult to subsequently remove unwanted ink and/or causing interaction of colored ink layers, causing a “ghost image” of the design to be visible from the other side of the panel and/or deleteriously affecting the light permeable material and/or an adhesive layer on the other side of the light permeable material.

U.S. Pat. No. 6,267,052, U.S. Pat. No. 6,899,755, and U.S. Pat. No. 6,824,639 also disclose methods of printing with substantially exact registration.

It is known to introduce a silver ink layer intermediate a white and black ink layer, in order to increase the perceived whiteness of the white ink, for example to provide a good background layer to a four color process, cyan, magenta, yellow and black (CMYK) design.

U.S. Pat. No. 6,212,805 discloses see-through graphic panels comprising light permeable materials partially covered with a translucent design superimposed on a translucent “base pattern”, typically white. A reverse image of the design is visible from the other side of the panel and the translucent nature of the design and base pattern enables the design visible from one side of the panel to be illuminated from the other side of the panel.

Metallization of transparent materials, including glass, plastic sheet and plastic film materials is common, for example to create mirror effect products including so-called one-way mirror products or solar protective glazing products, which still allow a clear view out of the window and provide a mirror effect from outside the window during daylight hours. The metallized layer is typically vacuum deposited in a sufficiently thin layer to be transparent, providing good visibility through the metallized layer.

Partially metallized layers have been disclosed in vision control panels, for example in perforated plastic film constructions comprising a metallized polyester film layer disclosed in U.S. Pat. No. 4,358,488, or as a continuous partially metallized transparent material acting as a supplementary one-way vision layer within an assembly, in the manner of one-way mirror glass, for example as disclosed in U.S. Pat. No. 5,773,110. However, none of the prior art discloses a metallic layer as part of the production process to achieve desired perceived colors of the partially applied layers of marking material or to enable thinner layers of ink in such panels, or to act as a barrier layer to ink or etching solvents, or to enable a more efficient production process.

“Demetallization” is a known process, for example used to provide a metallic decoration over selected areas of bags, pouches, envelopes or other enclosures in the packaging industry. A plastic film is coated typically by vacuum metallization, for example using aluminum to produce a silver effect. The metallized layer is then printed upon, typically by gravure or flexographic (flexo) printing with ink of a uniform color and/or providing a design, followed by a resist layer printed in a pattern over portions of the overall area, followed by an etching process. The film is typically printed roll-to-roll and the etching process is typically undertaken by passing the web through an etching bath. Thus, a partially printed area of a transparent film material is seen to have a uniform metallized color when viewed through the transparent film whereas, from the other side of the film, a different uniform color or a design is visible, for example promoting the brand or providing a description of the contents or any advisory notices. Transparent areas outside the resist enable the product being packaged to be seen through the packaging. When this process is used to make a direct mailing envelope, the demetallized areas typically include a “window” to see the address of the recipient printed on an enclosed letter or other document.

In such packaging and envelope products, there is no requirement to have good visibility from the inside of the packaging enclosure through the partially demetallized material. The metallized layer has a principal role of providing an attractive visual impression, typically of a reflective silver or gold color depending on the parent metal material that is used in the metallization process, typically aluminum or an aluminum alloy, and any tinting lacquer applied to one or both sides of the metallized layer, for example a yellowish layer to provide a gold effect to an otherwise “silver” colored aluminum layer.

Other prior art metallization and demetallization processes use a stencil, either a soluble stencil, as disclosed in U.S. Pat. No. 6,896,938, or an oil-based stencil, causing the metallisation not to adhere and re-evaporation of the aluminum also removes the oil, or a separate mask is located in the front of the substrate during metallisation.

These demetallization processes have not been used to make products that do not have a metallic appearance when viewed from one or other side of the substrate. In prior art packaging products, the metallized layer typically appears opaque, providing a solid, reflective appearance, for example of bright silver or gold appearance, and this layer obscures visibility of any ink or other marking material behind the metallic layer. The prior art demetallization methods are not suited to manufacturing the vast majority of commercially desirable one-way vision panels, for example which have advertisements or decorative designs on one side of a transparent material but have a black silhouette pattern seen from the other side, which enables good visibility through the panel, typically from the inside of a building or vehicle. Such products rely on the silhouette pattern not being significantly reflective from the inside, so that the eye is attracted by the objects on the outside. Reflective silver, gold or other metallic colors are not suitable for such applications, as they have the opposite characteristic, the metallic layer being highly reflective and therefore tending to obscure vision through the panel.

In the prior art of demetallization, any superimposed design, for example comprising indicia, is superimposed on discrete metallized areas, whereas in products according to US RE37,186, the design is superimposed on a silhouette pattern with intervening transparent areas over which the features or elements of a design, such as indicia, are perceived to “bridge”. The brain perceives the design and individual colors or features of the design independent of the silhouette pattern.

Breakage of glass through differential thermal expansions is a known, albeit rare, problem associated with prior art window graphics with or without transparency.

### SUMMARY OF THE INVENTION

According to an embodiment of the present invention, a panel comprises a sheet of imperforate light permeable material and a print pattern comprising a plurality of layers of marking material adhered to said light permeable material, said print pattern dividing said panel into a plurality of discrete areas of said marking material and/or a plurality of discrete areas devoid of said marking material, said panel comprising a metallized layer, wherein part of said print pattern when viewed from one side of the panel is of a different color to part of said print pattern when viewed from the other side of the panel, and wherein a part of the boundary of one layer of said marking material is in substantially exact registration with a part of the boundary of another of said layers of marking material.

A method of making a panel according to an embodiment of the invention includes the steps of:
(i) applying a mask to said one side of said light permeable material to define said print pattern,
(ii) applying layers of marking material to one side of said light permeable material, one of the layers being a metallized layer, and
(iii) removing a plurality of unwanted layers of said marking material from outside said print pattern, to leave a part of the boundary of one of said layers of marking material in substantially exact registration with a part of the boundary of another of said layers of marking material.

The light permeable material optionally comprises a metallized layer throughout either or both sides of the light permeable material.

One of the layers of marking material may be a metallized layer.

In some embodiments of the invention, a radiation-reflecting layer of marking material is visible from one side of the panel and a radiation-absorbing layer of marking material is visible from the other side of the panel. For example, a light-reflecting design is visible through a panel comprising a transparent material and a black layer of marking material is visible from the other side of the transparent material, forming a one-way vision panel. Alternatively, a black layer of marking material is visible through a transparent material and a light-reflecting design is visible from the other side of the transparent material forming another type of one-way vision panel. Optionally, the design comprises a design layer seen against a white background and, preferably, a metallized layer is intermediate the white layer and the black layer. The metallized layer, for example a layer of aluminum, is very efficient in acting as a transition between the black and white layers, making the white layer appear substantially whiter, brighter and more visually opaque than it otherwise would without the metallized layer. The metallized layer enables a white layer to act as an improved background to a design layer, for example a multi-color process design layer comprising cyan, magenta, yellow and black (CMYK), which are typically translucent inks.

In the context of this invention, the imperforate “light permeable material” is either a “transparent material” or a “translucent material”. The term imperforate does not exclude the possibility of the light permeable material having holes, for example for fixing a panel of the invention in position.

Examples of light permeable material include a rigid or semi-rigid sheet material, for example of glass, acrylic, polycarbonate, polyvinyl chloride, crystal polystyrene, polypropylene or polyester, or filmic material, for example of polycarbonate, polyvinyl chloride, polypropylene or polyester.

A “transparent material” has the conventional meaning of a material which allows an observer on one side of the material to focus through the material onto an object spaced from the other side of the material. A transparent material is “water clear” or tinted.

A “translucent material” has the conventional meaning of a material which allows light to pass through it but which does not allow an observer on one side of the material to focus through the material onto an object spaced from the other side of the material. Translucent materials include etched or etch-effect materials, and so-called deformé or obscure materials typically having one non-planar surface. In addition to the sheet and filmic materials referred to above, translucent materials include, for example, translucent paper, card or cardboard.

A “see-through graphic panel” or a “vision control panel” is a panel comprising a sheet of transparent material partially covered with a print pattern and a design formed on the sheet, the design being superimposed on or forming part of the print pattern.

A “one-way vision” panel is a see-through graphic panel comprising a color or design visible from one side of the panel which is not visible from the other side of the panel.

The “print pattern” subdivides the panel into a plurality of discrete printed areas and/or a plurality of discrete unprinted areas. The print pattern is opaque in panels according to US RE37,186 or translucent in panels according to U.S. Pat. No. 6,212,805. In such vision control panels, the print pattern typically comprises a regular pattern of dots, which may be circular, triangular, square, hexagonal or any other shape, or a pattern of lines, which may be straight or curved, or a pattern of interconnected or intersecting elements, for example to give the appearance of a perforated material or a grid pattern. The elements of the pattern may be regular, such as circles, squares, etc., in a regular or irregular layout or the elements may be irregular, such as in a stochastic pattern. It should be understood that the print pattern can be of any geometric arrangement that satisfies the above definition and that the above examples of print patterns are not limitative to any degree.

A cross-section can be taken through a panel of an embodiment of the invention comprising two outer edges of the sheet of light permeable material and alternate printed portions and unprinted portions of the print pattern.

A “design” comprises a “design layer” comprising at least one “design color layer”. The term “design” includes any graphic image such as indicia, a photographic image or a multi-color image of any type. A design is typically perceived to be visually independent of the elements of the print pattern. This feature can be tested by an observer adjacent to one side of the panel from which the design is normally visible, who moves away from the one side of the panel in a perpendicular direction from the panel until individual elements of the print pattern can no longer be resolved by the eye of the observer, the design remaining clearly perceptible. A design color layer does not extend over all the printed portions.

In order for the perceptibility of the design to dominate perceptibility of elements of the print pattern or the transparent or translucent areas, it is preferred that a panel be constructed such that a cross-section can be taken through any point within the area of a panel such that the average width of a plurality of the printed portions is less than 6 mm and the average width of a plurality of the transparent portions is less than 3 mm. If a panel according to one or more embodiments of the invention is intended to be principally observed from a distance of less than 1 m, it is preferred that the average width of a plurality the translucent portions and the average width of a plurality of the transparent portions both be less than 2 mm. However, these dimensions may be modified without deviating from the scope of the present invention.

The term “reflectivity” is used to describe the reflection characteristics of the surface of a material of infinite thickness and the term “reflectance” is used in relation to the surface of a material of defined thickness.

A “metallic layer” is a layer comprising a metal. Both a “metallized layer” comprising a thin deposit of metal, for example by vacuum metallization, and a “metallic ink” layer comprising metallic pigment, for example aluminum powder, are metallic layers.

A “metallized layer”, is typically produced by metallic vapour deposition under a vacuum, for example of aluminum, copper, nickel or zinc, typically from a wire of the parent material.

A “metallic ink” includes ink, paint or other marking materials comprising a metallic pigment. The use of a metallic ink, for example comprising aluminum powder, is known in the art to be applied between layers of black and white ink, or between two layers of white ink to assist the creation of a bright, visually opaque white surface, for example as a background to a design. To be effective in this role, a layer of metallic ink, needs to be of substantial thickness to provide the necessary transition of perceived color, for example a screen printed conventional silver ink would typically be of some ten microns thick. A metallized layer, for example of metallized aluminum, would typically be of less than 1 micron thickness to achieve the same or greater visual effect upon a superimposed white layer and any superimposed design color layers. Design color layers are opaque or translucent, for example four color process translucent cyan, magenta, yellow and process back deposits, typically intended to be seen against a white background.

“Demetallization” means a process of applying a metallized layer to a substrate and then selectively removing parts of the layer. Conventional removal methods include solvent etching, or water or other solvent applied to a soluble stencil, or digital demetallization by means of electro-erosion, for example using an IBM 4250 machine. An embodiment of the present invention optionally uses the application of an external force to the exposed surface of the layers of marking material comprising a metallized layer, for example an external adhesive or abrasive force.

Difficulties have been experienced in the prior art methods of partial printing of a substrate with substantially exact registration, for example of solvents from layers of ink, especially digital solvent inkjet printed design inks, migrating through previously printed layers and damaging a stencil material and/or the substrate and/or a layer of pressure-sensitive adhesive in a self-adhesive film assembly. For example, solvent attack on a stencil layer typically reduces its effectiveness as a stencil, for example causing discoloration of the substrate under the stencil intended to be transparent, for example by associated migration of small pigment particles. “Ghost” images often result from reactivation of previously cured or semi-cured solvents and ink resins. The provision of a metallized layer according to one or more embodiments of the invention has been found to substantially eliminate these problems of conventional methods of printing with substantially exact registration. Furthermore, the effectiveness of the metallized layer in performing these functions enables the other layers of marking material to be relatively thin and therefore printable by printing methods which deposit relatively thin layers, typically of 0.5-10 gm/m² deposit, such as litho, flexo and gravure printing methods and digital inkjet methods, compared to the conventional screen printing methods which require layers of sufficient thickness, typically 7-10 micron, to create the desired visual effect. The reduced thickness of layers also reduces the problems of under-etch and over-etch with the solvent etch embodiments, and makes them easier to remove by any method. Furthermore, the reduced thickness of the payer assists the protection of ink and substrate by subsequent overlamination, for example by a self-adhesive film, for example a self-adhesive polyester or perforated film, or overlaminate with “hot melt” adhesive, or liquid overlamination, as the incidence of air inclusions at the edges of the print pattern is substantially reduced. Air inclusions provide points of weakness which can result in subsequent delamination, for example through the heating and expansion of the air pockets, and cause optical distortion reducing the quality of through vision.

Thermal ink layers also assist the subsequent application of imaged, self-adhesive panels to a window as they provide less resistance than thicker, conventional printed portions to the action of a squeegee used in applying such products to a window.

The panel comprises a metallized layer, typically vacuum metallized, with a thin layer of metal, typically of aluminum or aluminum alloy, typically of thickness between 100 to 750 Angstroms and an Optical Density (OD) of 0.2 to 4.0. Methods of metallization include “sputtering” and the use of ceramic “vessels” from which aluminum is vaporized. Metallization processes commonly comprise an initiation stage, for example a corona treatment prior to metallisation. The thin metallized layer protects any underlying layers of marking material and the substrate from chemical attack or undesirable dyeing or other discoloration of the light permeable material. If applied directly to a transparent material, the metallized layer is sufficiently thin, for example 100-200 Angstroms, 0.2-1.0 OD less than 0.1 gm/m², and has a sufficiently plane surface for good optical clarity of through vision, to enable an observer to focus on an object spaced from the other side of the transparent material. A very thin transparent metallized layer also allows the use of inks or other marking material that can be bonded to it and are capable of being etched away or otherwise removed with it, but which would not bond satisfactorily to the light permeable material. To be visibly opaque or to act as an optical transition layer between black and white ink layers, the metallized layer is preferably of a greater thickness, say 400-750 Angstroms, 2-4 OD, 1-2 gm/m².

The methods of enabling the removal and the removal of the unwanted portions of marking material include, among others, the following:
1. A “resist and solvent etch” method. A mask “resist” in the form of the print pattern is applied to layers of marking material. The etching process typically removes the metallized layer as well as any ink above and/or below it. In some embodiments, however, the metallized layer is not removed.
2. A “water-activated stencil” method. A mask in the form of a water-activated stencil (a negative of the desired print pattern) is applied to the light permeable material, followed by the layers of marking material. The unwanted marking material, including portions of a metallised layer, is typically removed by means of a water-activated stencil of the desired print pattern, for example a water-soluble or water-expansive stencil material. The metallised layer has discontinuities at the edges of a relatively thick stencil layer which, together with the use of water permeable ink layers above, allow the subsequent migration of water to the water-activated stencil. The term “water” in this context includes any aqueous or non-aqueous liquid.
3. A “release layer stencil “method. A release layer stencil is printed on the substrate and the layer(s) of ink and the metallization layer are applied over it. The unwanted marking material is removed by an external force applied to the exposed surface of the superimposed layers of marking material, for example by the application and removal of an adhering layer, for example by the application and removal of a self-adhesive film or the application of a material with a substantial membrane tensile strength when cured, for example a plastisol ink. Alternatively, the application of an external force comprises jetting with a suitable medium, for example water- or air-jetting with or without a suitable abrading medium comprising solid particles, for example abrading powders such as plastic granules.
4. A “direct” method. A first layer mask is applied to the light permeable material in the form of the desired print pattern. A second layer is then applied over the first layer and the exposed areas of light permeable material. The second layer adheres to the first layer but does not form a strong bond to the exposed portions of light permeable material, the interface acting as a release surface. At least one further layer of marking material, including a metallized layer, is applied over the second layer. The unwanted layers of marking material are removed by an external force in a similar fashion to the third method.
   Other methods may alternatively be used without deviating from the scope of the present invention.

Ink marking material layers can be selected from a wide range of options, including acrylic, cellulose, nitrocellulose, ethyl cellulose, epoxy, polyvinyl acetate (PVA), urethane and polyamide.

The four methods provide different ways of enabling and effecting the removal of unwanted marking material, to leave layers of marking material within a print pattern in substantially exact registration.

However, in various methods according to one or more embodiments of the present invention, the metallized layer enables thinner individual layers and overall thickness of marking material than conventional methods of printing with substantially exact registration. The incorporation of a metallized layer in a see-through window graphic panel may have a number of advantages in relation to the performance of buildings, vehicles or other enclosures to which they are applied, including, among others:
(i) improved reflectivity of solar radiation, reusing cooling energy requirements and costs,
(ii) improved reflectivity of internal thermal radiation, reducing heating energy requirements and costs, and
(iii) improved thermal conductivity of the glazing system.

Referring to these advantages in more detail
(i) solar radiation through windows causes heat gain internally, typically requiring air conditioning or natural ventilation systems to maintain acceptable internal temperatures, especially during the summertime in most climates. See-through graphic panels, according to US RE37,186 or U.S. Pat. No. 6,212,805 automatically reduce solar heat gain from Ultra Violet and Infra Red (IR) radiation, as well as glare, but a metallized layer provides additional benefits, in particular with respect to solar heat gain, providing an efficient reflective surface within the print pattern.
(ii) The reflective surface is effective, of course, in both directions and helps to maintain internal heat and save energy used for this purpose, especially in the wintertime in most climates. A metallized layer in a see-through graphic panel between an internally facing black layer (provided for good see-through visibility characteristics) and a white layer (provided primarily as a background to a design layer or decorative color) reflects internal heat and the black layer acts as radiator of that heat back into the internal space.
(iii) The provision of a metallized layer, for example in a print pattern of lines or interconnected elements, provides a layer of much greater thermal conductivity than the glass or any applied film, adhesive or ink, enabling the transfer of absorbed heat from one area to another within a glass lite or pane, thus reducing any differential thermal expansion that would otherwise occur. Conventional window graphic systems have been associated with a number of glass fracture incidents thought to have been caused by differential solar thermal heating of windows in differently colored areas. Darkly coloured areas absorb more heat than lighter colored areas, causing differential thermal expansion stresses which have on occasion caused glass breakage, perhaps initiated at points of relative weakness in the glass, for example by impurity inclusions in the glass. Even without any applied graphics, glass is known to suffer spontaneous failure through temperature change, including tempered (toughened) glass. While aluminium metallization is typically adopted in one or more embodiments of the present invention for effecting a brighter perceived white layer in a vision control panel, other metals, some with greater thermal conductivity, can be incorporated as an alternative or additional layer of metallization, for example of tin oxide, tungsten, nickel, chromium, copper, titanium, platinum, and tantalum, without deviating from the scope of the present invention.

Yet another thermal conductivity benefit of the metallized layer is in the curing of ink layers applied to the Part Processed Material above (following) the metallized layer. UV curing is assisted by reflection of UV radiation back through the ink layer being cured. Solvent ink curing typically depends on a combination of heat and air flow, the metallized layer reflecting heat and, additionally, conducting part of the heat absorbed in darker imaged areas to assist the curing of lighter inks within a graphic design. In both UV and solvent ink systems, the required energy and time of curing is reduced for any subsequently applied layer of ink.

Additional and/or alternative advantages and salient features of the invention will become apparent from the following detailed description, which, taken in conjunction with the annexed drawings, disclose preferred embodiments of the invention.

### BRIEF DESCRIPTION OF THE DRAWINGS

Referring now to the drawings which form a part of this original disclosure:

FIGS. 1A-1M, 2A-2J, 3A-3H, 4A-4K, 5A-5K, 6A-6H, 7A-7G, 8A-8I, 9A-9L, 10A-10H, 11A-11J, 12A-12M, 13A-13G, 14A-14I, and 15A-15L illustrate embodiments of a first method;

FIGS. 16A-16E, 17A-17F, and 18A-18I illustrate stages in the production of panels according to embodiments using a second method;

FIGS. 19A-19H, 19J, 20A-20G, 21A-21L, 22A-22K, 23A-23F, 24A-24G, 25A-25H, and 26A-26I illustrate stages in the production of panels using a according to embodiments using a third method; and

FIGS. 27A-I illustrate stages in the production of panels according to embodiments using a fourth method.

### DETAILED DESCRIPTION OF EMBODIMENTS OF THE PRESENT INVENTION

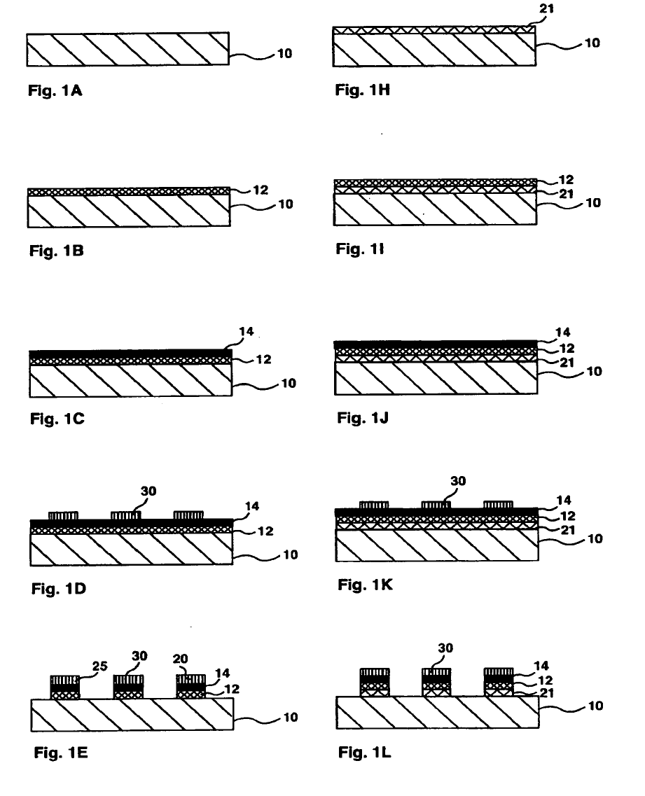

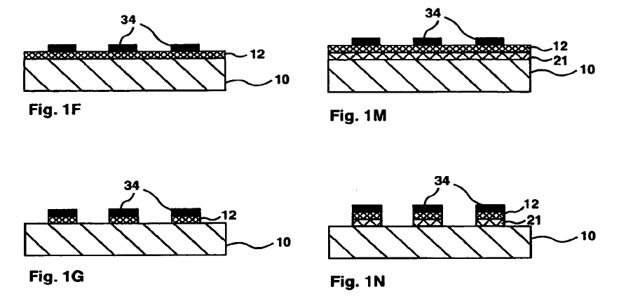

The following FIGS. 1A-27G are sequential, diagrammatic cross-sections illustrating the production of panels according to various embodiments of the invention. Each of the four basic methods has several variants. Each of these described method variants or method embodiments result in product embodiments which comprise a substantially imperforate light permeable material, a print pattern comprising a plurality of layers of marking material, one of the layers of marking material being a metallized layer and at least a part of the boundary of one of the layers of marking material being in substantially exact registration with a part of the boundary of another of the layers of marking material.

FIGS. 1A to 15L illustrate embodiments of the first method, which uses a solvent etch to remove layers of unwanted marking material from outside a resist layer.

FIG. 1A illustrates a light permeable material 10, typically a transparent material, which is coated with metallized layer 12, for example of aluminum, as shown in FIG. 1B. In FIG. 1C, a radiation-absorbing layer 14, for example a layer of black ink, is applied to metallized layer 12. A resist 30 in the form of the desired print patent, typically transparent, is applied to the radiation-absorbing layer 14 in FIG. 1D. FIG. 1E illustrates a finished panel following solvent etching of the unwanted marking material outside the resist, exposing light permeable material 10. The superimposed layers of marking material 12 and 14 with resist layer 30 are in substantially exact registration, in the form of the print pattern. In a variant of this embodiment, a color-amending layer 21, for example a colored lacquer, is applied to substrate 10, as shown in FIG. 1H. FIGS. 1I to 1K show the successive applications of metallized layer 12 and radiation absorbing layer 14 and resist layer 30, before the solvent etching away of unwanted portions of marking material, leaving the finished panel of FIG. 1L, in which an amended color of metallized layer 12 is seen through the light permeable material 10. For example, a yellow color-amending layer 21 and aluminum metallized layer 12 would resulting in a gold appearance of the metallized layer 12 through light permeable material 10. In another variant, a light-absorbing resist 34 is applied to the metallized layer 12, as illustrated in FIG. 1F, followed by solvent etch demetallization to leave the panel of FIG. 1G with a radiation-reflective, metallic appearance visible through the light permeable material 10 and a radiation-absorbing material, for example black, visible from the other side of the panel. A color-amending layer 21 can be used as shown in FIG. 1M to produce the panel of FIG. 1N, for example modifying the appearance of an aluminum metallized layer 12 to appear gold through the light permeable material 10 and a black, radiation-absorbing layer 34 visible from the other side of the panel.

In one or more of the embodiments using solvent etch, the layers of marking material are of a type, for example cellulose inks, which can be etched away using a solvent, for example sodium hydroxide (caustic soda).

In these descriptions of FIGS. 1A-N and in subsequent descriptions of the figures, it should be understood that the terms radiation-reflective, light-reflective and white are interchangeable and that metallic layer 12 is typically radiation-reflective and light-reflective, also that the terms radiation-absorbing, light-absorbing and black are interchangeable, as are the terms metallic ink and silver ink.

In all figures, the methods and embodiments described are not limited to the manufacture of see-through graphic panels but can be used to make other types of graphic panels or non-graphic panels, for example security seals or labels, panels in which radiation-reflecting and radiation-absorbing properties are used for non-visual purposes, for example the reflection and/absorption of solar heat, UV radiation or glare, or as components in assemblies such as conventional or micro-wave ovens, or as packaging for products, for example to be heated in a conventional or micro-wave oven.

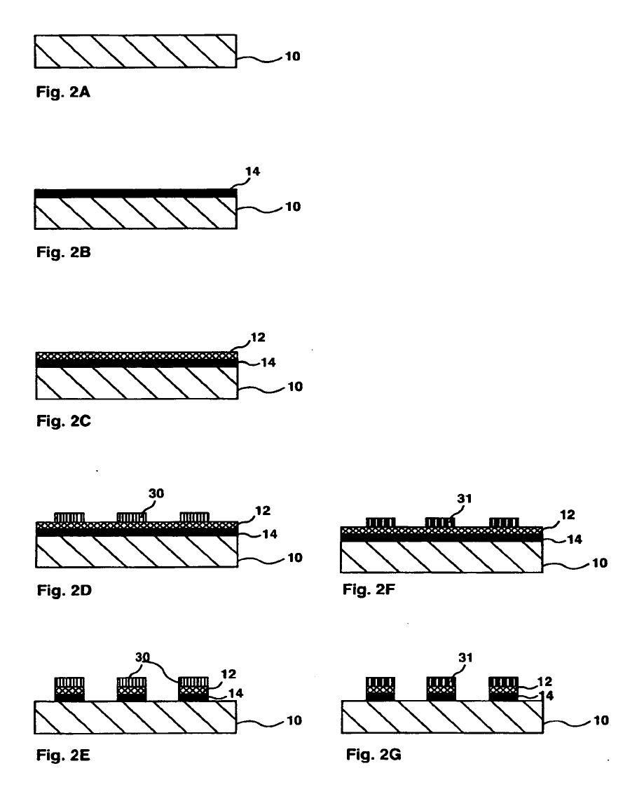

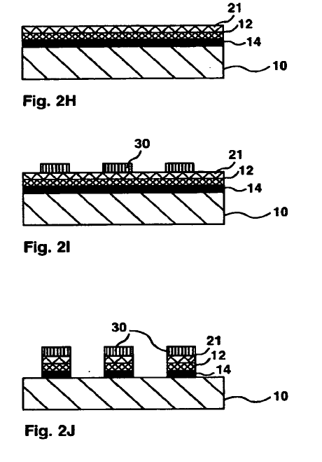

FIGS. 2A-J illustrate the stages of making other embodiments with, typically, a black appearance from one side and a reflective metallic appearance from the other side, but in this case with the black layer 14 being visible through the light permeable material 10 and the metallized layer 12 being visible from the other side of the panel. Light permeable material 10 in FIG. 2A is coated with black layer 14 in FIG. 2B, and metallized layer 12 in FIG. 2C, followed by clear resist 30 in the form of the print patent in FIG. 2D, or color-amending resist 31 in FIG. 2F, resulting, following solvent etching, in the finished panels if FIGS. 2E and 2G respectively. FIGS. 2H-J illustrate an alternative means of amending the color of the metallized layer, by means of a uniform color-amending coating 21 in FIG. 2H.

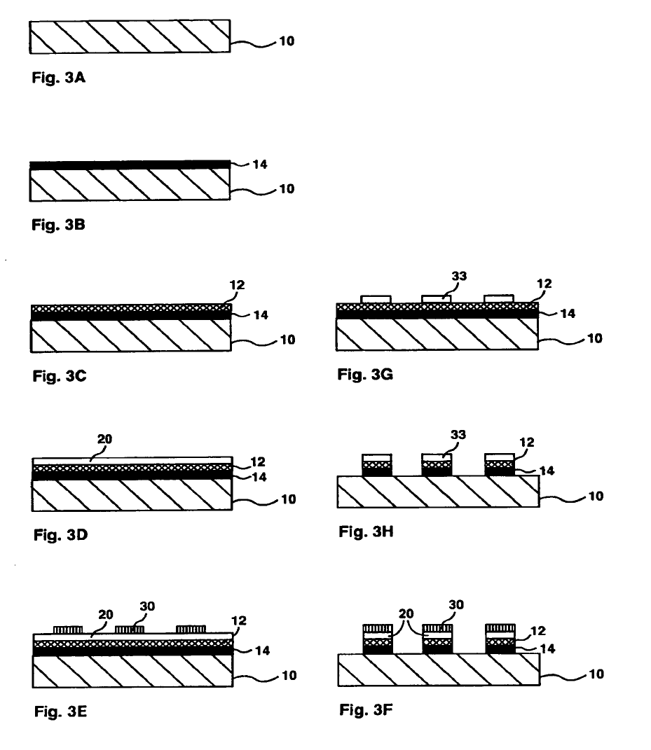

FIGS. 3A-F illustrate the use of metallized layer 12 intermediate black layer 14 and white layer 20 to increase the brightness or visual opacity of a white or other light-reflective layer 20, for example a light blue or light green layer 20.

The light permeable material 10 of FIG. 3A is coated with black layer 14 in FIG. 3B and metallized layer 12 in FIG. 3C, followed by white or other light-reflective layer 20 in FIG. 3D, clear resist layer 30 in FIG. 3E which, following solvent etching, results in the finished panel of FIG. 3F. Alternatively, a white or other radiation-reflective resist 33 can be used as illustrated in FIG. 3G, followed by solvent etching to result in the finished panel of FIG. 3H. The metallized layer 12 enables much thinner layers of marking material individually and overall to achieve a dark-colored color visible from one side and a white or other light-color visible from the other side of the panel. Various conventional methods required screen printing to achieve the necessary thickness of layers for the required visual effect or alternatively many layers of white and typically several layers of black to achieve the required effect with printing systems that typically deposit less thickness of ink, for example litho, flexo and gravure printing.

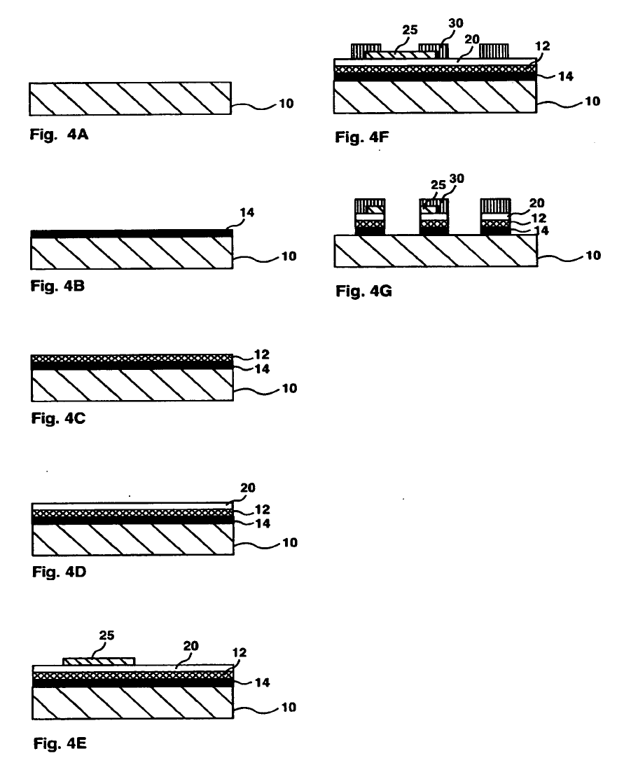

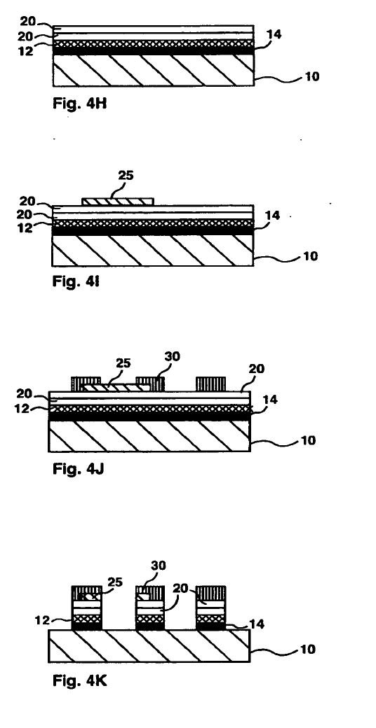

FIGS. 4A-K illustrate the manufacture of panels according to US RE37,186 having a design on one side not visible from the other side. FIGS. 4A-D are similar to FIGS. 3A-D, followed by the application of design 25 in FIG. 4E which a design color layer covers only part of the area of the panel, either a single, “spot” or “line” design color layer or a multi-color process design color layer as part of a multi-color process design layer which may extend over the whole area of the panel or part of the panel. In FIG. 4F, clear resist 30 is applied in the form of the print patent, followed by solvent etching to leave the finished panel of FIG. 4G. Even with the benefit of using metallized layer 12 in one or more embodiments of the present invention, it may still be desirable to incorporate a plurality of light-reflecting layers 20, for example two white layers or one white and one light, translucent layer of another color, as illustrated in 4H, followed by the required design 25 in FIG. 4I, the clear resist layer 30 in FIG. 4J and the finished panel following solvent etching in FIG. 4K. The abrasion resistance of surface designs is optionally increased by means of one or more layers of clear ink or lacquer applied to the design, preferably before the removal of unwanted ink, for example to maintain optical clarity of a transparent material where the unwanted marking material is removed. Otherwise, the subsequent overall application of a lacquer would reduce the optical clarity of through vision owing to the topography of the exposed surface of the clear material over the different thicknesses of the partially imaged substrate. This would act like déformé glass, making it impossible to focus on an object spaced from the other side of the panel. Application of the clear protective layer before the removal stages maintains good optical transparency in the finished panel.

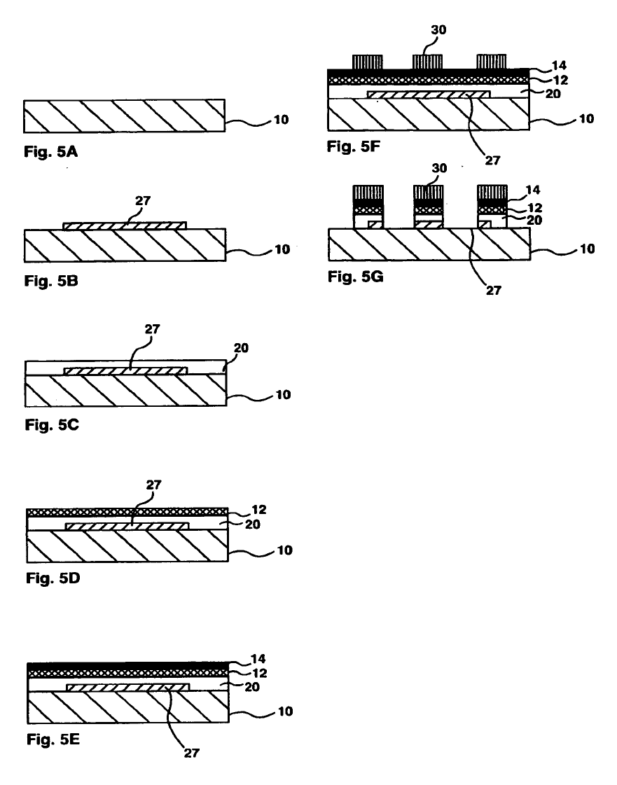

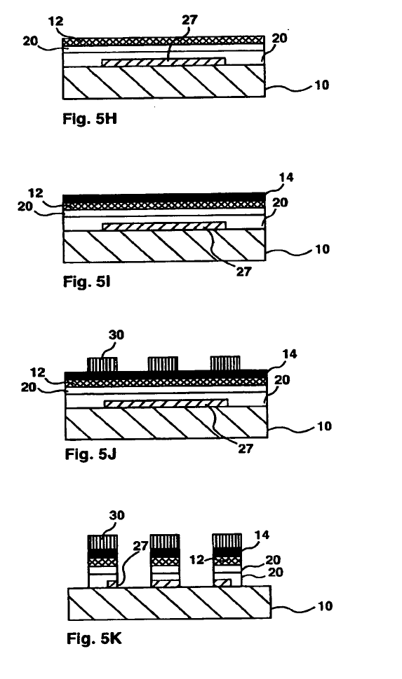

FIGS. 5A-K result in a one-way graphic panel in which design 27 is visible through the light-permeable material but a black layer 14 is visible from the other side, enabling good visibility through the panel from the other side. The light permeable material 10 in FIG. 5A is reverse printed with design 27 in FIG. 5B, white layer 20 in FIG. 5C, metallized layer 12 in FIG. 5D and black layer 14 in FIG. 5E, followed by clear resist 30 in FIG. 5F and the finished panel in FIG. 5G following solvent etching. FIGS. 5H-K illustrate a similar sequence but with a plurality of layers 20. Optionally, not illustrated, a black resist layer 34 could be used instead of the black layer 14 and clear resist 30 layers illustrated. The one or more embodiments of the invention with a design reverse printed directly onto the sheet of light permeable material have an additional benefit in that the design color layers are protected by subsequently applied layers, typically white, metallic and black layers, which provide abrasion resistance.

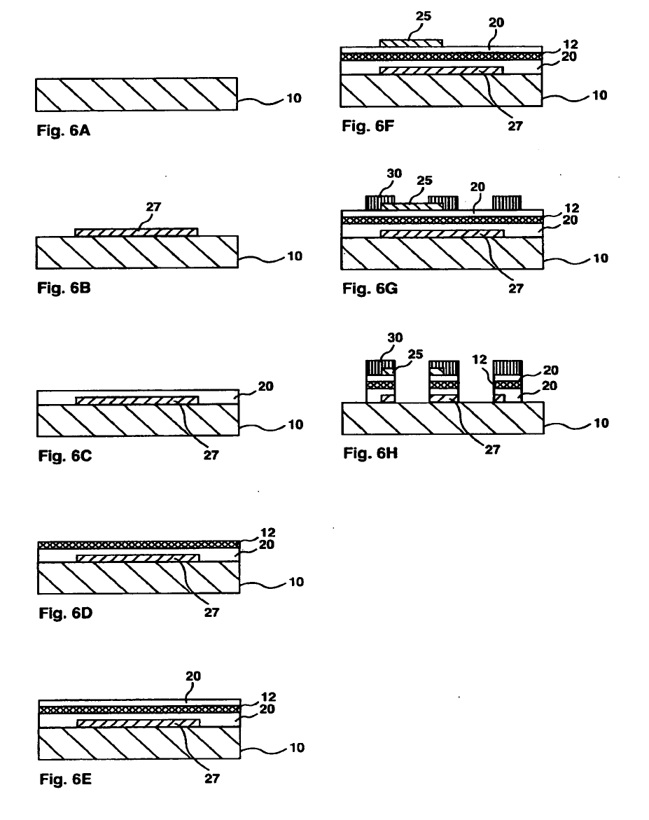

FIGS. 6A-H illustrate the stages of manufacture of a panel according to US RE37,186 having a design 27 visible through the light permeable material 10 and another design 25, which may optionally be the same design as 27, visible from the other side of the panel. The production method is similar in FIGS. 6A-D as in FIGS. 5A-D, followed by another white layer 20 in FIG. 6E and right-reading design 25 in FIG. 6F. Following the application of clear resist 30 in the form of the print patent, solvent etching results in the finished panel of FIG. 6H.

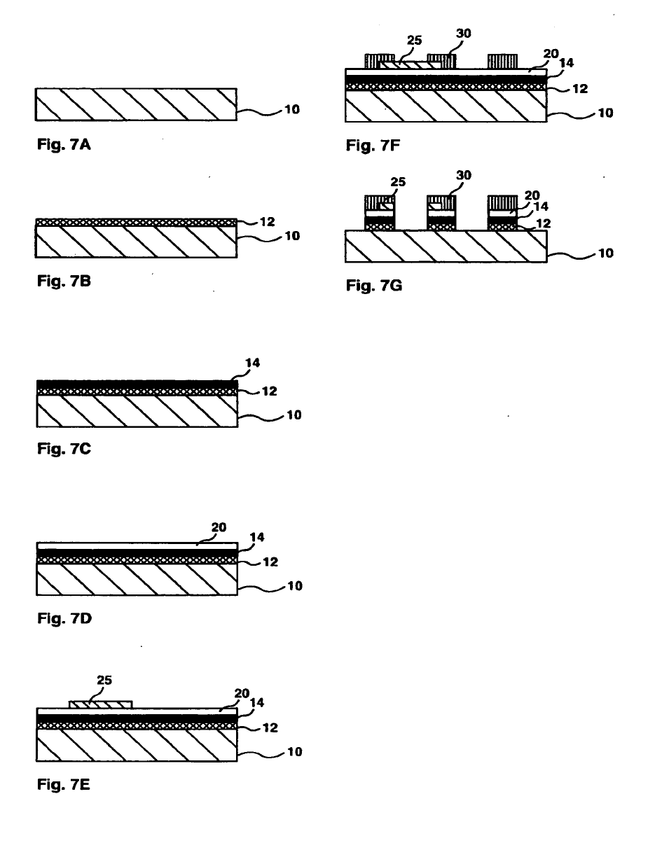

FIG. 7A-G illustrate the use of a transparent metallized layer 12 directly applied to the light permeable material 10 in FIG. 7B, for example to act as barrier to the migration of solvents into light permeable material 10 from subsequent layers of marking material, including black layer 14 in FIG. 7C, white layer 20 in FIG. 7D and design layer 25 in FIG. 7E, followed by clear resist 30 in FIG. 7F. Solvent etching results in the finished panel of FIG. 7G. This use of a metallized layer applied directly to the substrate can also be used for the purposes of creating a “metallic black” or other metallic color seen through the transparent metallized layer 12, with or without design 25.

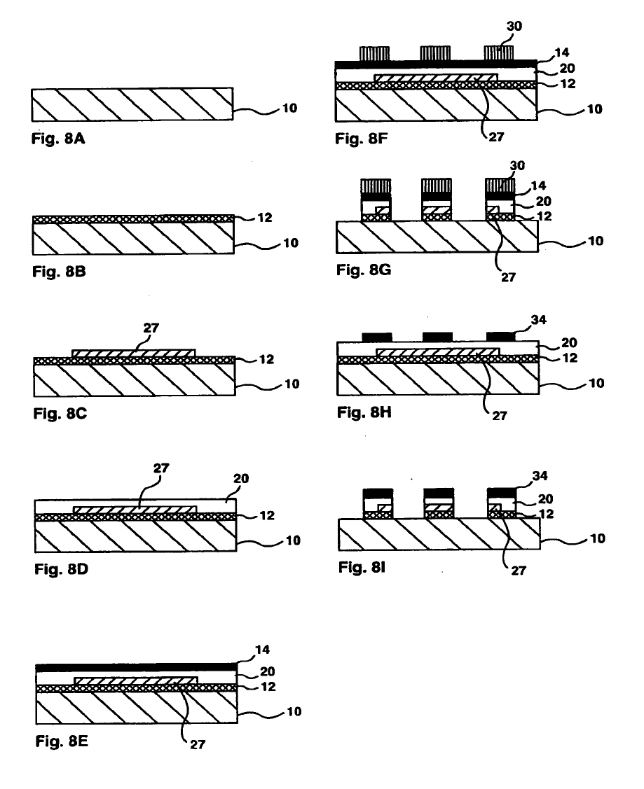

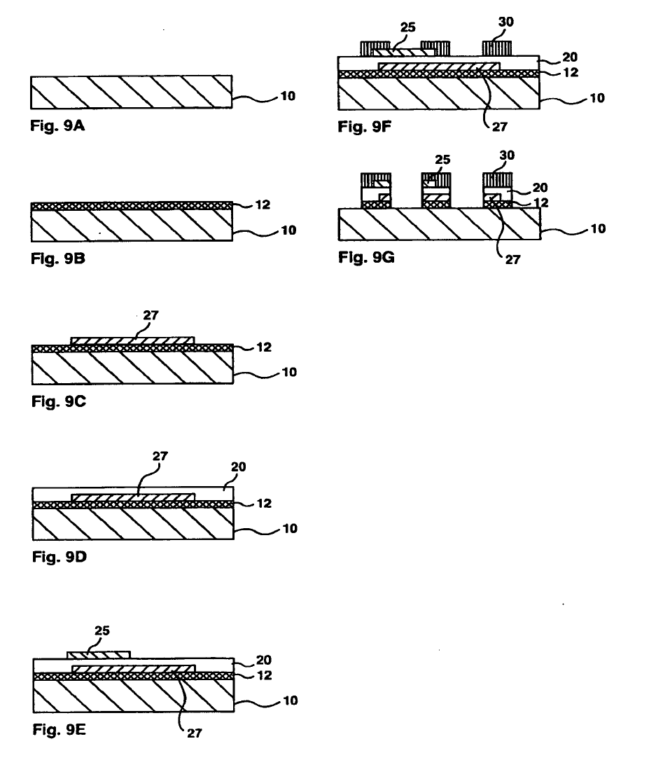

FIGS. 8A-I illustrate the use of a transparent metallized layer 12 and a design 27 reverse printed onto metallized layer 12, as shown in FIG. 8C, followed by white layer 20 in FIG. 8D, black layer 14 in FIG. 8E, clear resist layer 30 in FIG. 8D and the finished panel of FIG. 8G following solvent etching. Alternatively to FIG. 8E, black resist layer 34 is applied to white layer 20, as shown in FIG. 8H, resulting in the finished panel of FIG. 8I following solvent etching.

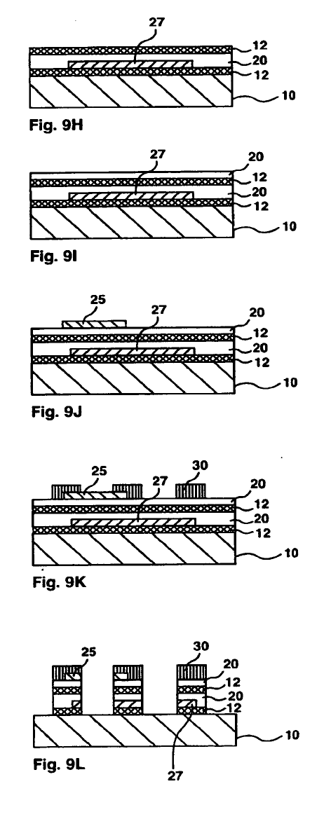

FIGS. 9A-L illustrate the production of a panel with two designs using the methodology of FIGS. 7A-8I. Optionally, a metallized layer 12 is applied intermediate white layers 20 to improve the visual whiteness or opacity of white layers 20, for example as illustrated in FIGS. 9H-L.

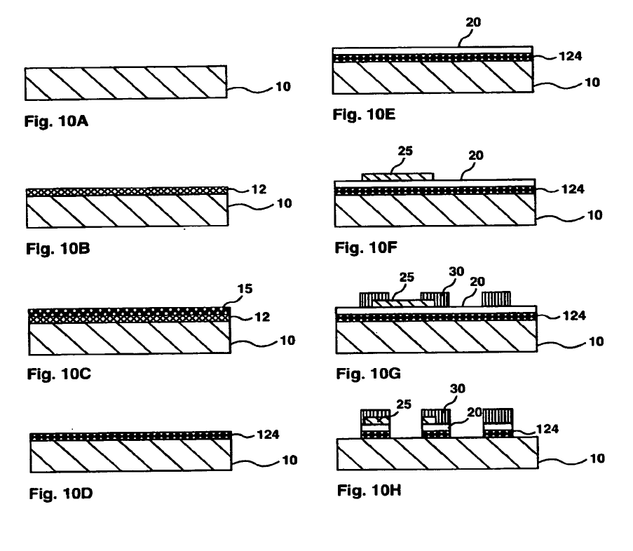

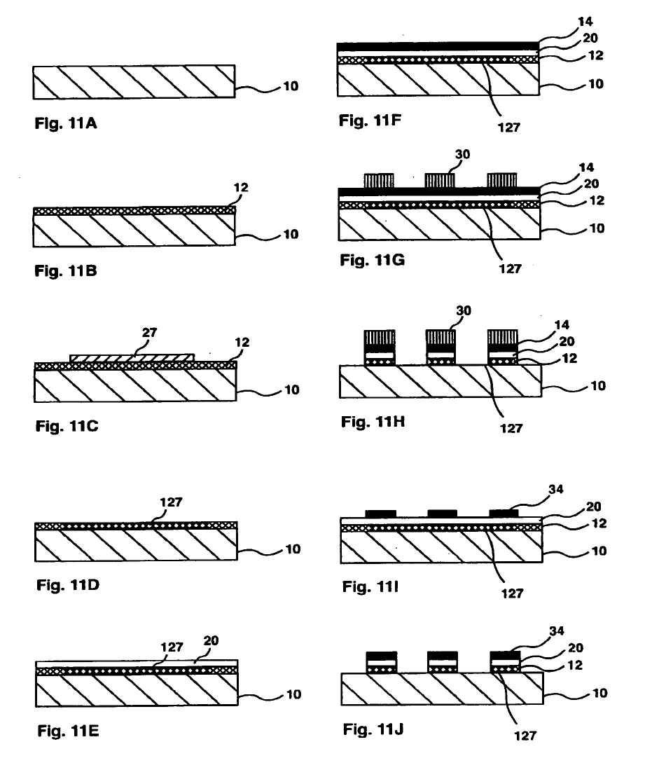

In the embodiments of FIGS. 10A-H, 11A-J and 12A-M metallized layer 12 itself is amended in color by a subsequently applied layer.

Aluminum is commonly anodized and then colored, a process used for example for coloring aluminum window frames and producing aluminum signs. A dye is absorbed into an oxidized layer of the aluminum, typically by printing an ink containing dye onto selected areas of the aluminum and subsequently water jetting the surface ink after sufficient dye has been adsorbed into the aluminum sheet, which seals the treatment. While the aluminum wire rod used in the metallizing process may be dyed, the color will vary with depth, causing variation in the color greytone applied to a substrate. Therefore, it is typically better to amend the color of the metallized layer by anodizing and dyeing it after it has been deposited on the substrate.

The light permeable material substrate 10 of FIG. 10A has a metallic coating 12 in FIG. 10B, which is then oxidized before the application of marking material 15 in FIG. 10C. Marking material 15 is a dye, typically black, which is absorbed by oxidized layer 12, typically of aluminum. It is then subjected to water jetting, which removes surplus material and seals the color into anodized layer 124 in FIG. 10D. A suitable marking material 15 is Aluprint manufactured by Clariant UK Ltd. In FIG. 10E, optional layer or layers 20, typically white, or another metallized layer or silver ink, then white, are applied to colored anodized layer 124, typically followed by design layer 25, as shown in FIG. 10F. Resist layer 30, typically transparent, is applied in the form of the required print pattern in FIG. 10G and the panel is subject to a solvent etch, leaving the required layers in the required print pattern, as illustrated in FIG. 10H.

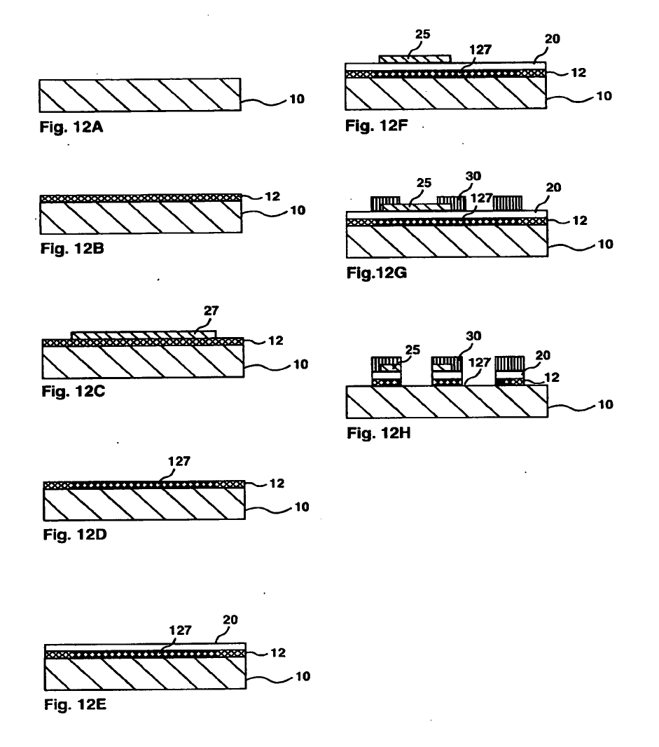

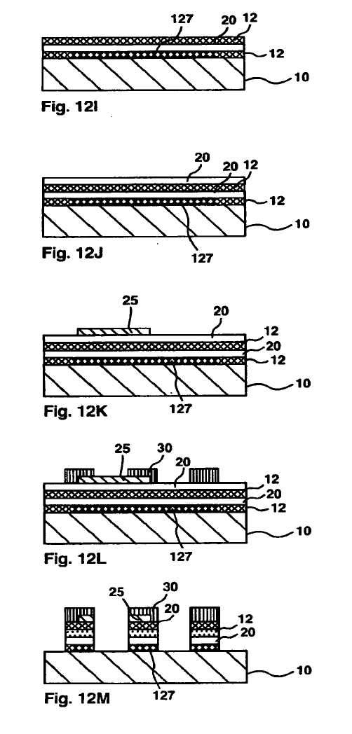

FIGS. 11A and 11B are similar to FIGS. 10A and 10B but in FIG. 11C design layer 27 is a dye which is absorbed into anodized layer 12 to form design color layer 127 visible through the light permeable material 10, as illustrated in FIG. 11D. In FIG. 11E, optional background layer or layers 20 are added, typically of white or white then another metallized layer or silver ink, followed by layer 14, typically black, in FIG. 11F. Transparent resist layer 30 is added in FIG. 11G and the panel is etched to leave the required layers in the required print pattern in FIG. 11H. Alternatively, a black resist layer 34 is used, as illustrated in FIG. 11I, the etching process resulting in the required layers in the required print pattern of FIG. 11J. In both FIGS. 11H and 11J, a uniform color print pattern is visible from the print side, typically black, and design layer 127 is visible against background layer 20 through light permeable material 10. FIGS. 12A to 12M illustrate embodiments in which design 25 is visible from the print side of the panel and design 127 is visible through the panel, the particular layers in each figure being identified by the same nomenclature as previously described.

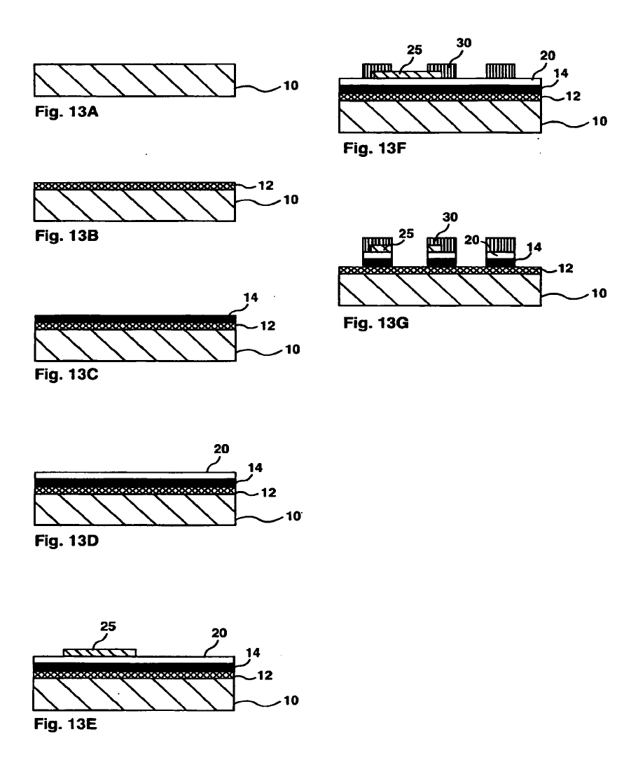

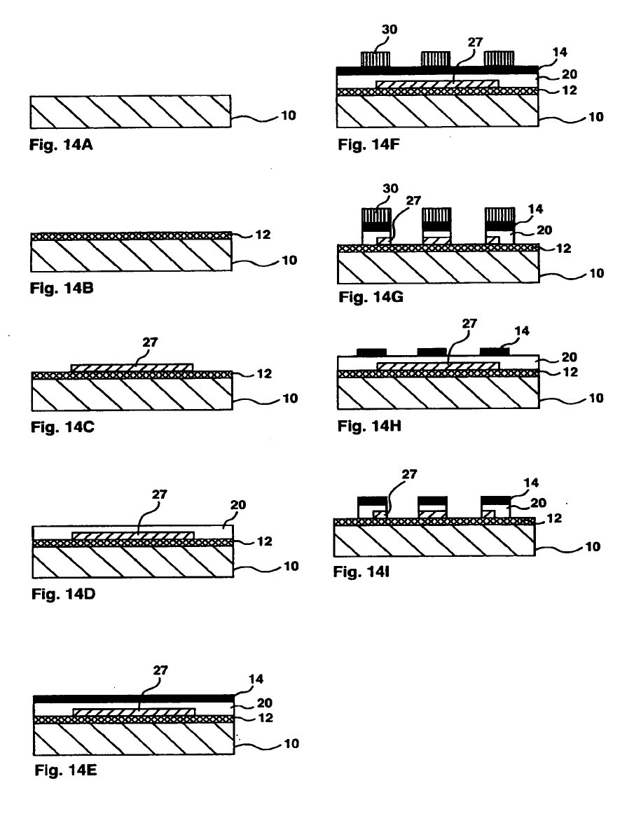

FIGS. 13A-15L illustrate methods of producing panels in which metallized layer 12 applied directly to light permeable material 10 is not etched away in any location but remains across the whole area of the panel in the resulted finished products of FIGS. 13G, 14G, 14I, 15G and 15L. In FIG. 13B, the light permeable material 10 of FIG. 13A is coated with transparent metallized layer 12, followed by black layer 14 in FIG. 13C, white layer 20 in FIG. 13D, design 25 in FIG. 13E, clear resist layer 30 in the form of the desired print patent in FIG. 13F, to produce the finished panel of FIG. 13G following solvent etching. In this embodiment, the solvent removes the layers of marking material 14, 20 and 25 but not the metallized layer 12, for example—solvent removes—inks 14 and 20 but does not remove metallized layer 12, for example of aluminum. FIGS. 14A-14I are stages of production using similar materials with reverse printed design 27 visible through light permeable material 10 and transparent metallized layer 12 in FIG. 14I, which allows good through vision in between the black layer 14 portions of the print patent.

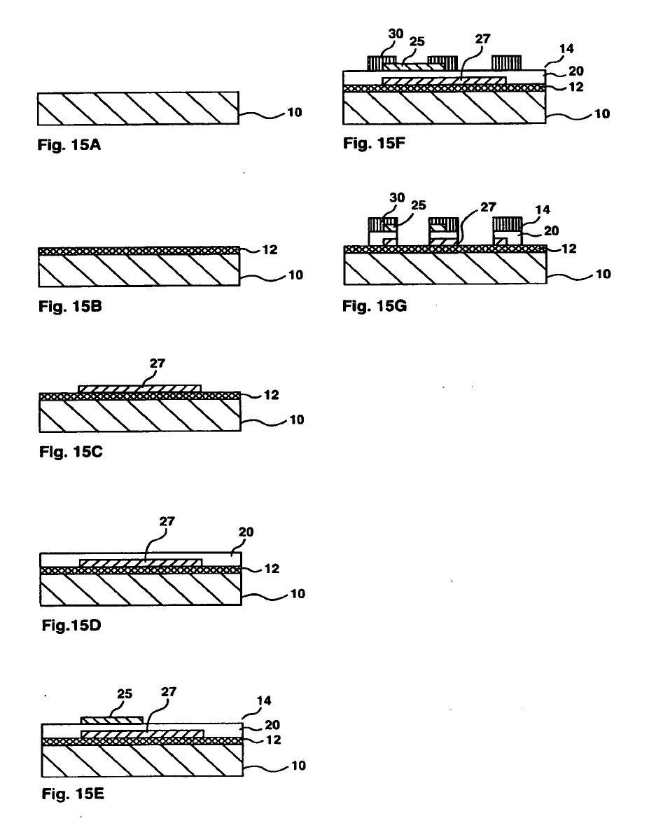

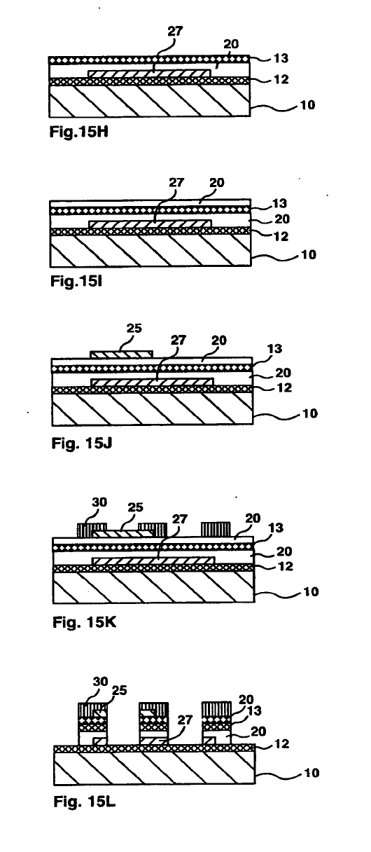

FIGS. 15A-G utilize similar materials to produce the product of 15G with design 27 visible through the light permeable material 10 and transparent metallised layer 12 and design 25 visible from the other side of the panel. FIGS. 15H-L illustrate how these methodologies can be used in conjunction with an intermediate silver ink layer 13 which is removed by the solvent etch process along with the other layers of marking material ink, leaving the transparent metallized layer 12 across the whole of the area of light permeable material 10.

The invention of US RE37,186 and corresponding patents in 21 countries has been practiced worldwide, for example commonly seen on the windows of buses, taxis and retail windows as one-way vision advertisements. However, the “Resist Method 5” disclosed in this patent has not been used for any of this production, owing to the problem of differential under-etch or over-etch caused by design color layers of different extent and thickness. Surprisingly, the demetallization process has been found to be effective in manufacturing such products, in view of the thin layers of ink or other marking material applied according to one or more embodiments of the present invention, typically by gravure, litho or flexo ink.

The invention is not limited to manufacturing products having an opaque print pattern, for example according GB 2 165 292, but can be used to make partially printed panels having a translucent print pattern, for example according to U.S. Pat. No. 6,212,805, for example according to the embodiments of FIGS. 7A-G, 8A-I, 13A-G and 14A-I but omitting the black layer 14 from these sequences. Unlike various conventional panels, various embodiments of the invention enable a design or a white, translucent layer to be visible through a transparent substrate and a thin partially metallized layer.

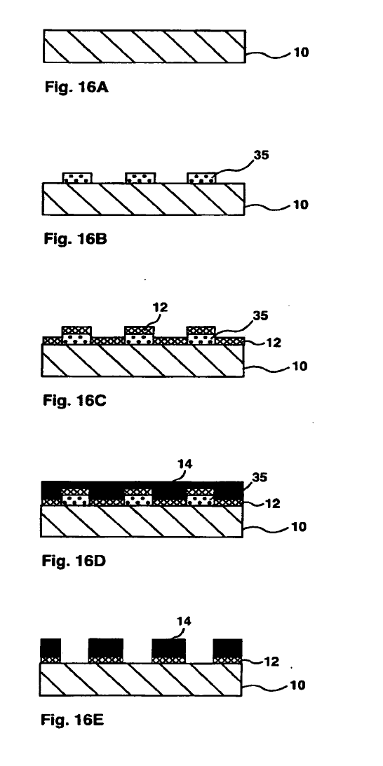

FIGS. 16A-18I illustrate stages in the production of panels using the second method, that of removing unwanted marking material by means of a water-activated stencil 35. The stencil layer is water expandable or water soluble. The layers of marking material, including the metallized layer, are applied over the stencil. Typically the metallized layer is applied directly over the stencil layer and the light permeable material and the stencil layer is of sufficient thickness and the metallized layer is sufficiently thin such that it cannot be deposited in a continuous layer over the edges of the stencil layer but leaves water permeable gaps or discontinuities in the metallized layer. The other layers of marking material are applied and the unwanted marking material is subsequently removed by the application of water which permeates through the other layers of marking material and the metallic layer at the edges of the stencil, which is activated and facilitates the removal of the unwanted layers of marking material and the stencil itself, for example in a water bath, or a water jetting process.

In FIG. 16B, the water-activated stencil 35 is applied to the light permeable material 10 of FIG. 16A. Suitable water-activated stencils include, among others, those disclosed in U.S. Pat. No. 6,896,938, applied in a relatively thick layer, for example within the range of 3 to 10 micron. Such thickness causes the metallized layer 12 applied in FIG. 16C to not form a continuous layer across the edges of the stencil but to allow subsequent permeability or migration of water through the metallized layer into the water-activated stencil layer. Black layer 14 is water permeable and applied as illustrated in FIG. 16D. Upon the application of water, for example in a water bath, the water permeates through black layer 14 and discontinuities in metallized layer 12, into the water-activated stencil 35. This stencil 35 is either water soluble or water-expansive ink. The application of water, optionally with oscillation or water jetting or brushing, removes the water-activated stencil and the layers of marking material above it to leave the panel of FIG. 16A with metallized layer 12 visible through light permeable material 10 and black layer 14 visible from the other side.

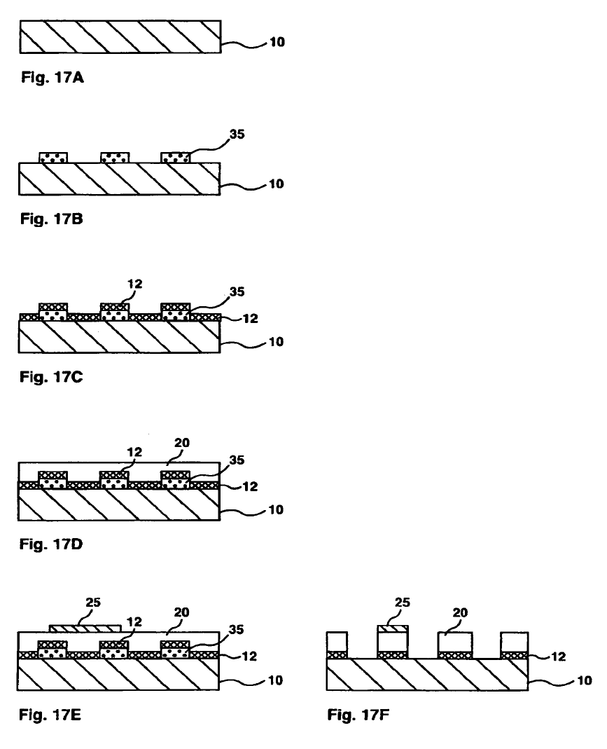

FIGS. 17A-C are similar to FIGS. 16A-C, followed by white or other light-colored layer 20 in FIG. 17D and, optionally, design 25 in FIG. 17E, followed by the removal of unwanted marking material by the application of water to leave light colored-layer 20 and/or design 25 visible from the print side of the panel and the metallic layer 12 visible through the light permeable material. Optionally, metallized layer 12 is sufficiently thin to be transparent, resulting in a see-through graphics panel according to U.S. Pat. No. 6,212,805 having a translucent design 25 and a translucent background layer 20.

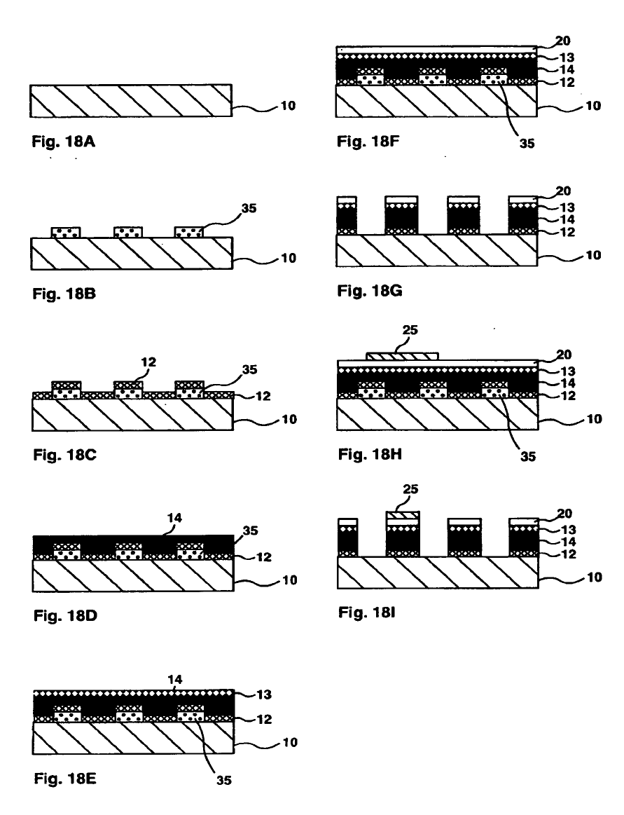

FIGS. 18A-I illustrate an embodiment of the invention utilizing a water-activated stencil 35 and a layer of metallic ink 13, typically a silver ink, intermediate the black and white layers of a one-way vision panel according to US RE37,186. FIGS. 18A-18C are similar to FIGS. 17A-C, which illustrates a transparent metallized layer 12 applied to the water-activated stencil. A colored, typically black, layer 14 is added in FIG. 18E, followed by white layer 20 in FIG. 18F. This can be “finished” by the removal of unwanted marking material by the application of water to provide a white on black or other partially printed panel appearing of one color on one side and a different color from the other side or the process can be continued as illustrated in FIG. 18H by the application of design 25 and then the application of water to leave the finished panel of FIG. 18I.

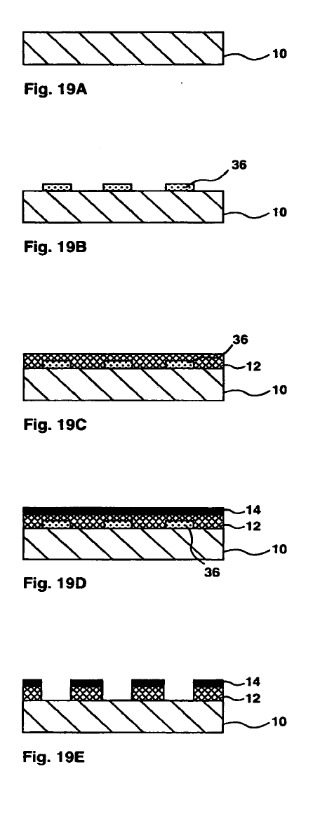

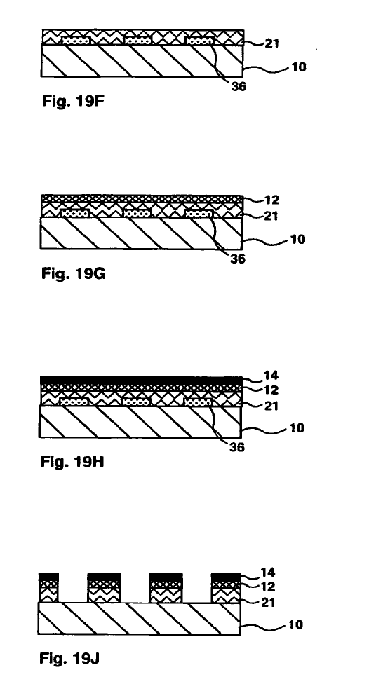

FIGS. 19A-26I illustrate stages in the preferred method 3, utilizing a release layer stencil 36 which can be removed with the layers of marking material above it by application of an external force, to leave the desired layers of marking material in the desired print patent in substantially exact registration. The term release layer is used herein to distinguish it from the water activated stencil of the second method. The release layer is typically much thinner than the stencil of the second method and has typically a low bond to the light permeable material. The layers of marking material, including the metallization layer are applied over the release layer and the unwanted layers of marking material and typically the release layer are subsequently removed by the application of a force to the exposed surface of marking material. Examples of a removing force including the application and removal of an adhesive surface for example a self-adhesive film or plastisol ink, or, water jetting, air jetting or jetting with a solid abrading medium. self-adhesive film. The release layer stencil 36 in FIG. 19B is applied to the light-permeable material of FIG. 19A, followed by metallized layer 12 in FIG. 19C and radiation-absorbing, typically black, layer 14 in FIG. 19D. The unwanted material is removed by an external force to leave the finished panel of FIG. 19E comprising a partially printed panel appearing typically black from one side and a metallic color, for example the “silver” appearance of an aluminum metallized layer 12, visible through the light permeable material. A different colored metallized layer can be obtained by the application of a color-modifying or color-amending lacquer 21 as shown in FIG. 19F, followed by metallized layer 12 and black layer 14, followed by the removal of unwanted marking material by the application of an external force to leave the finished panel of FIG. 19J. If the color-amending layer 21 is yellow, for example, a gold color is be visible through the panel and a black print pattern is visible from the other, print side of the panel.

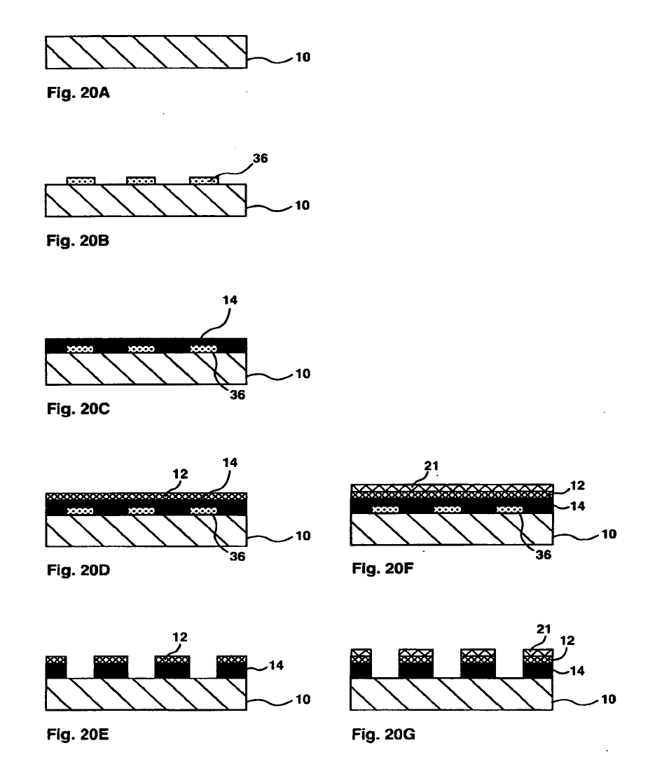

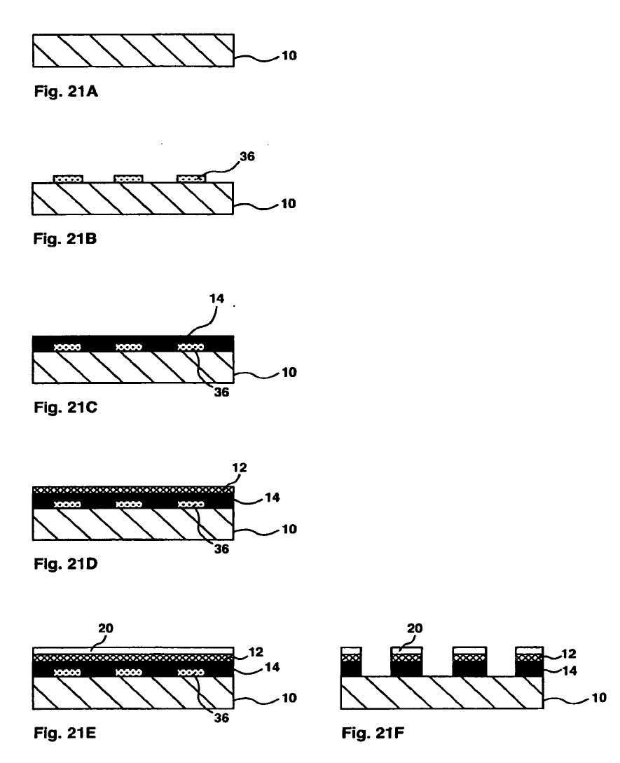

FIGS. 20A-G illustrate a similar production method but with black layer 14 visible through light permeable material 10 and metallized layer 12 visible from the other side, in FIG. 20E, or another metallized color by means of color-amending lacquer 21, in FIG. 20G.

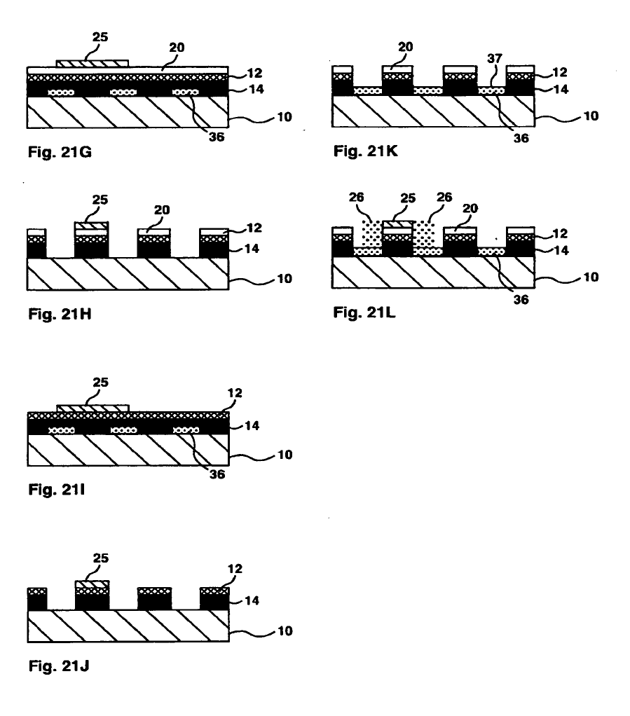

FIGS. 21A-F illustrate the preferred embodiment of making a panel having a uniform radiation-absorbing layer 14, typically black, visible from one side of the panel and a uniform radiation-reflective, light color 20 visible from the other side of the panel. The light permeable material 10 of FIG. 21A is partially coated with release layer stencil 30 in FIG. 21B. Release layer stencil 36 is covered by radiation-absorbing layer 14, typically black, in FIG. 21C, followed by metallized layer 12 in FIG. 21D and radiation-reflective layer 20, typically white, in FIG. 21E. The white layer 20 is receptive to a design imaging system or, optionally, has an additional, print-receptive coating applied to it. To produce a white on black, one-way vision panel, the unwanted marking material is removed by the application of an external force, for example by air or water jetting, or the application and removal of a self-adhesive film, to leave the finished product of FIG. 21F with all the layers in substantially exact registration within the print pattern. FIGS. 21A-E illustrate the preferred method of manufacturing panels according to US RE37,186 by means of metallization. The product of FIG. 21E is a “Part Processed Material” that can be manufactured, preferably roll to roll, and sold in roll form or sheeted to printers for converting into one-way vision panels. Design 25 is applied to the layer 20 in FIG. 21G and the unwanted marking material removed by the application of an external force, to leave the finished panel of FIG. 21H having a design or one side not visible from the other side, which provides good through vision. Alternatively, a see-through graphic panel according to US RE37,186 is made by applying the design layer 25 to the metallized layer 12 of FIG. 21D, as shown in FIG. 21I, followed by the removal of unwanted marking material by means of the application of an external force, to leave the finished panel of FIG. 21J, which has black layer 14 visible through the light permeable material 10 and design 25 visible against metallized layer 12 from the other side of the panel.

This embodiment of the invention can use any light permeable material but preferably a filmic light permeable material and preferably a transparent film, for example a clear, transparent polyester film of between 6 to 200 micron thickness, typically 38 to 125 micron, to enable roll to roll production. The film is optionally print-treated, for example by the application of a surface coating, for example comprising pvc, during or following the film production process. For the production of one-way vision widow graphics according to US RE37,186, the film is optionally a self-adhesive film, for example having a transparent pressure-sensitive adhesive, for example an acrylic based pressure-sensitive adhesive, applied to the filmic “facestock”, and a protective film liner, for example a silicone-coated paper or silicone-coated polyester film, applied to the pressure-sensitive adhesive. Such a self-adhesive film assembly is to be understood as an optional substrate or light permeable material 10 in various embodiments of the invention. Even if a paper liner is used and the self-adhesive assembly is not light permeable during printing, upon removal of the liner and application of the filmic facestock by means of the adhesive to a window, the resultant panel comprising window glass, adhesive and film is transparent or translucent where not covered by the print pattern of marking material.

The metallized layer 12 according to one or more embodiments of the present invention enables the other layers of the print pattern to be relatively much thinner than the conventional methods of making such one-way vision panels, which typically required solvent ink screen printed layers of black and two layers of white, or black, silver and white ink, each of wet thickness of 15-20 micron, dry thickness of 7-10, micron for each layer (20-30 micron dry thickness overall). Various embodiments of the present invention allow the printing of thin black and white layers of ink, for example the gravure or flexo printing of a black ink layer and a white ink layer. Suitable inks include acrylic, cellulose, nitrocellulose, ethyl cellulose, epoxy, polyvinyl acetate (PVA), urethane and polyamide, typically of 2 to 5 micron dry thickness which, in conjunction with an aluminum metallized layer of less than 1 micron, results in an overall thickness of all the plurality of layers of marking material, typically comprising a black layer, a metallized layer, a white layer and an optional design layer of less than 20 micron and preferably less than 15 micron, and more preferably less than 10 micron, substantially thinner than the conventional ink thickness of typically 20-35 micron for the same number of layers. There are a number of alternative release layer stencil materials, including organic, solvent based inks that are normally used for one type of substrate, for example paper, which do not adhere to the light permeable material, for example of PVC or PVC print-treated polyester. There are many conventional inks that are typically used in a stencil release layer role, for example in tamper-evident labels or seals, for example revealing indicia such as “VOID” when a label or seal is removed, which are optionally used as a stencil release layer according to various embodiments of the present invention.

Furthermore, it has been found with one or more embodiments of the present invention, surprisingly, that a much thinner release layer stencil can be used. In the conventional stencil methods of US RE37,185 and U.S. Pat. No. 4,925,70, a relatively thick stencil layer of say 8 to 10 micron dry thickness has been used, in the belief and experience that a thick and sharp-edged stencil layer is required to provide a “stress notch” and initiate, under an external force, an “ink fracture mechanism” of the other layers of marking material, in order to remove the unwanted marking material. However, with the much thinner layers of marking material made possible by one or more embodiments of the present invention, a release layer stencil of 2 to 5 micron is satisfactory. Optionally, a release layer stencil does not have its primary release surface adjacent to the surface of the light permeable material but is a permanent release layer or a surface treatment of even less or no thickness with the primary release surface adjacent to the first layer of marking material. The release layer stencil is sufficiently thin to allow a continuous, unbroken layer of metallization to be applied over it or over a subsequently applied layer of marking material and so produces an effective barrier against the migration of solvents, other liquids or small particles. As well as enabling the use of mass production, more cost-efficient printing processes such as roll to roll gravure, flexo or litho printing, the reduced overall thickness substantially assists the subsequent removal of unwanted marking material, for example by reducing the required pressure, volume and time of water jetting, or enabling the efficient, roll to roll application and removal of a sacrificial layer of adhesive material, for example of self-adhesive film or plastisol ink, which removes the unwanted release layer stencil and unwanted marking material above it, or just the marking material above a clear, permanent, release layer stencil.

The white layer 20 is preferably receptive to the particular imaging system of design layer 25, for example digital solvent inkjet printing of a multi-color process, for example four color process cyan, magenta, yellow and black. For some imaging methods, an optional additional, print-receptive layer is applied to layer 20, also white or a clear translucent or transparent print-receptive layer to maintain a preferred white background to the printing of design layer 25.

In yet another variant, the product of FIG. 21F is a “New Part Processed Material” according to U.S. Pat. No. 6,267,052 and U.S. Pat. No. 6,899,775, in which light-reflective layer 20, typically white, is receptive to an imaging system which is addressed to the both the printed portions and unprinted portions of light permeable material 10 but only adheres to form a durable marking material on the printed portions, on light-reflective layer 20, and does not form a durable marking material, and preferably leaves no deposit, on the unprinted portions of the light permeable material. For example, layer 20 is an ink which is receptive to thermal transfer pigmented resin, which adheres to the receptive ink layer 20, for example Coates Vynalam™ (a trademark of Sun Chemical, Japan), but does not adhere to light permeable material 10, so producing a panel of FIG. 21H without the need for any removal of unwanted marking material. As another example, in FIG. 21K, a permanent release layer stencil 36 remains on light permeable material 10 following the application of an external force to the assembly of FIG. 21E, which removes marking material layers 14, 12 and 20 above the release layer stencil 36 but not the release layer stencil itself. Release surface 37 in FIG. 21K is such that when design 25 is addressed to remaining layers of marking material and exposed portions of light permeable material 10, for example by digital UV inkjet, in FIG. 21L, it forms a durable design 25 on white, receptive layer 20, but does not adhere to and does not form a durable image material where it impinges upon release surface 37, where it forms non-durable design portions 26, for example cured UV globules that can be easily removed, for example by an “air knife” leaving the finished panel of FIG. 21H.

Embodiments of the invention have been reduced to practice, in particular in a comprehensive testing program in relation to the method of FIGS. 21 A-G. A Part Processed Material was first produced comprising a: 75μ thick polyester film with a pvc print-treatment comprising gravure-printed inks with metallization as previously described. This Part Processed Material was test-printed with a variety of design imaging systems including the following digital inkjet machines:
(i) Mimaki JV3 and JV5 with OEM “eco solvent” inks,
(ii) Nur Fresco with full solvent inks,
(iii) Roland Soljet PRO 2V with OEM supplied inks, and
(iv) Mutoh Spitfire 65 with “soft solvent” inks.

The Part Processed Material was also found to be printable by laser printer.

In each case the unwanted marking material was successfully removed by applying and removing an adhesive coated polyester laminate, resulting in successful removal of both the laminate and unwanted marking material, leaving the desired layers of marking material within the desired print pattern in substantially exact registration.

With regard to the production of Part Processed Materials or New Part Processed Materials, one of the problems with substantially imperforate self-adhesive assemblies is that, following removal of the liner, during application of the self-adhesive film to a window, it is necessary to remove any trapped air between the adhesive layer and the window. This is typically done by means of an application fluid, for example a mixture of water with a small amount of soap, which enables the film to be positioned and squeegeed until the entrapped air is forced towards and out from an edge of the self-adhesive film. This process is facilitated, even to the extent of avoiding the need for application fluid in some cases, by the incorporation of fine “tunnels” of air between the surfaces of the adhesive and the window. Such methods are disclosed in U.S. Pat. No. 5,296,277, U.S. Pat. No. 5,362,516, U.S. Pat. No. 5,141,790 and U.S. Pat. No. 5,897,930, typically achieved by means of a deformed liner, typically embossed with a raised pattern which leaves recesses in the adhesive upon removal, typically an intersecting, grid pattern. However, such conventional methods are not typically suited to clear transparent self-adhesive films intended to remain transparent, to enable through vision. The air tunnels, however much the film is squeegeed, remain visible as optical interference patterns. However, an optional feature of one or more embodiments of the present invention is to align the tunnel pattern with the print pattern, an easy method of which is to have a print pattern of lines registered to mask air tunnels produced by an embossed liner, so that the tunnels are within the width of the lines. While it would be difficult to register a print pattern of lines transverse to the web of a roll of self-adhesive film, or to a grid or discrete dot patterns, it is relatively easy to register printed lines printed along the web length with embossed lines on a liner that has been manufactured to exacting standards, for example using the micro-replication technology of 3 M, which is used to manufacture such embossed liners in 3 M self-adhesive film assemblies. A self-adhesive Part Processed Material or New Part Processed Material, following imaging and removal of the liner, can be applied to a window with relative ease by squeegeeing primarily in the direction of the lines and the air tunnels under the lines which are masked by the line print pattern. This arrangement does not interfere with the clarity of vision through the transparent portions of the panel between the lines. The micro-tunnels also allow “outgassing” from rigid plastic sheets, for example acrylic sheets, following the application of such self-adhesive assemblies.

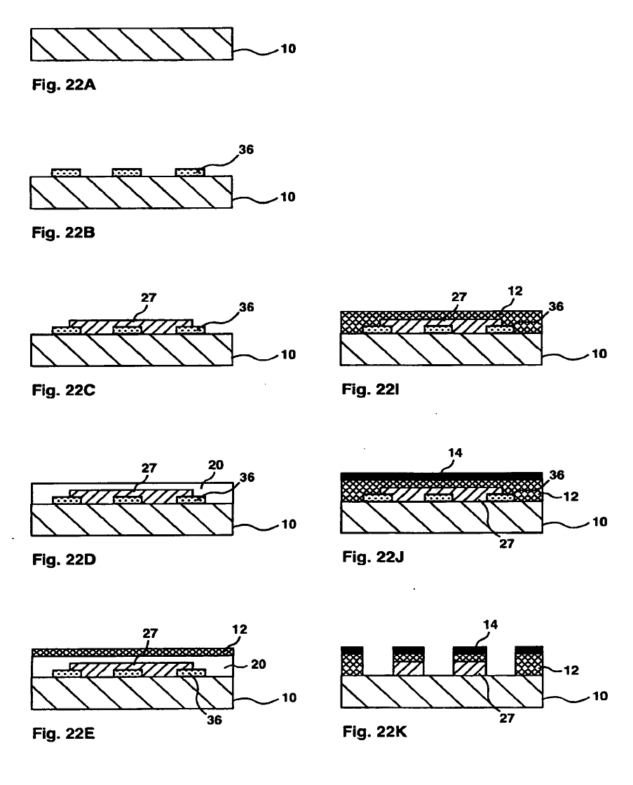

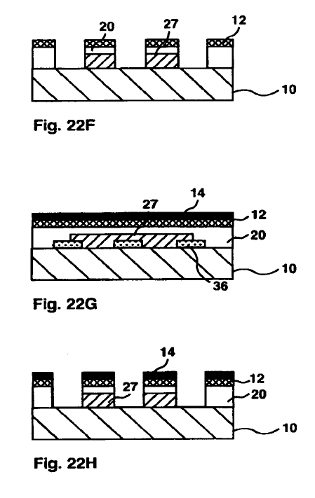

FIGS. 22A-K illustrate the production of a one-way vision panel having design 27 reverse printed over the release layer stencil 36, to be right-reading against a metallized layer in the finished panel of FIG. 22F. FIGS. 22G and H illustrate the production of a one-way vision panel with a design 27 visible through light permeable material 10, against white layer 20 with intermediate metallized layer 12, and black layer 14 visible from the other side of the panel.

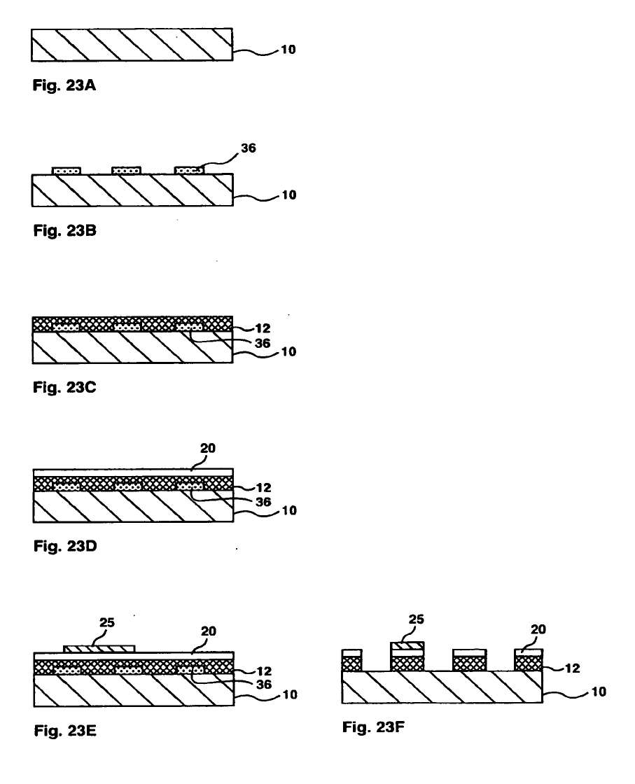

FIGS. 23A-F illustrate the production of a panel having a metallic layer 12 visible through light permeable material 10 and design 25 visible against white layer 20 from the other side. Optionally, metallized layer 12 is sufficiently thin to be transparent, resulting in a see-through graphic panel according to U.S. Pat. No. 6,212,805 having a translucent design 25 and a translucent background layer 20.

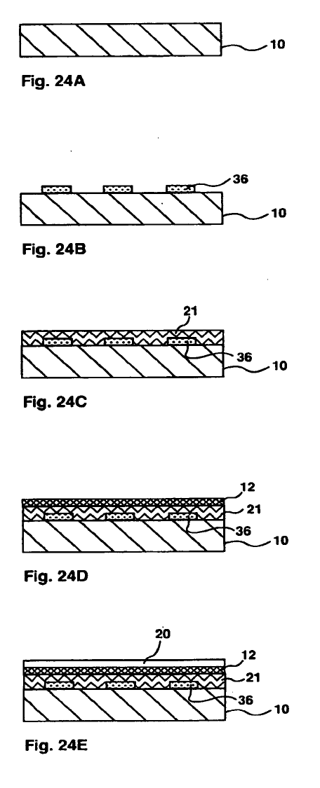

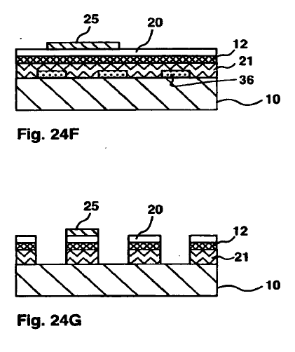

FIGS. 24A-G illustrate the production of a similar panel to FIG. 23F except for the incorporation of color-amending lacquer 21, for example to provide a gold appearing metallic color visible through permeable material 10 using an aluminum metallized layer 12.

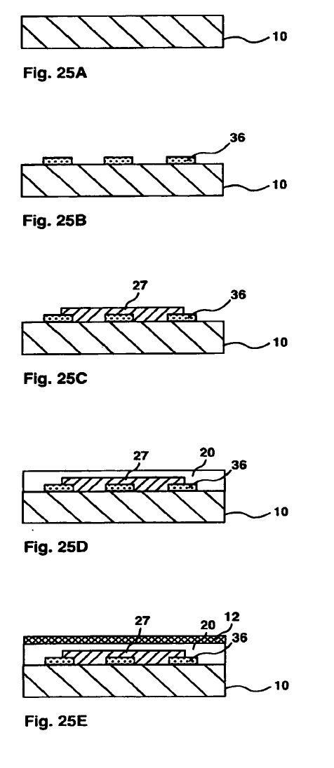

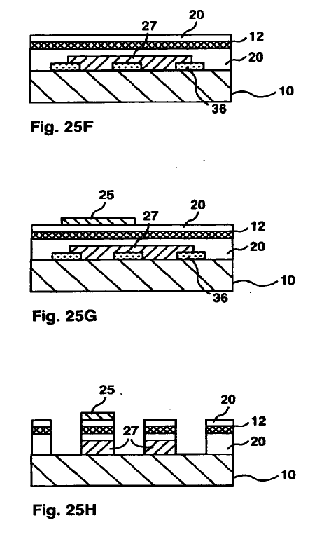

FIGS. 25A-H illustrate the production of a panel in FIG. 25H having a design 27 visible through the light permeable material and design 25 visible from the other side, using similar methodology as in FIGS. 23A-G.

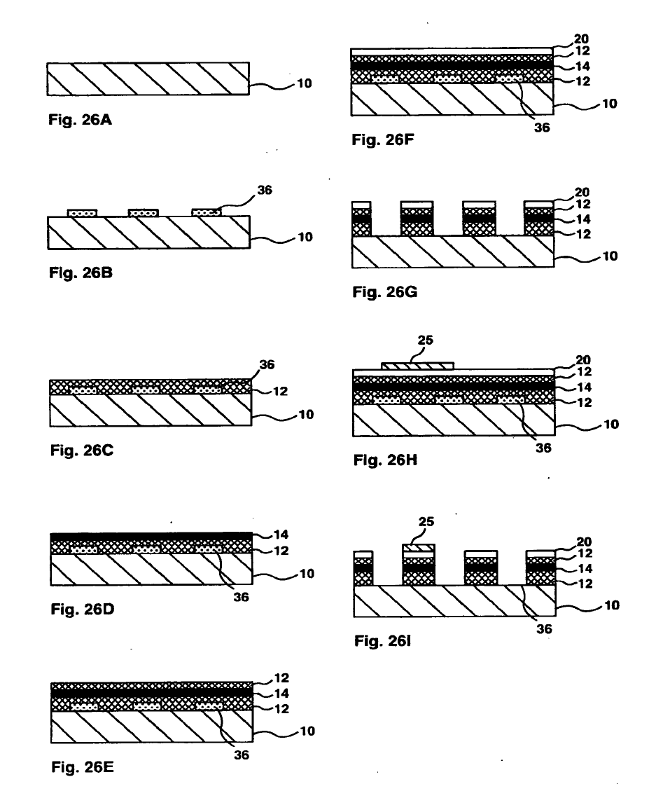

FIGS. 26A-I illustrate the production of a panel utilizing a transparent metallized layer 12 applied over release layer stencil 36, which enables black layer 14 to be visible through light permeable material 10, and a second metallized layer 12 intermediate black layer 14 and white layer 20. Both metallized layers 12 and the other layers of marking material and the stencil are removed outside the print pattern by the application of an external force. Alternatively, a transparent metallized layer 12 in FIG. 26C is imaged with a design or a print-receptive coating then a design, followed by a white and/or another metallized layer and, optionally, a blade layer, for example to produce the panel of Fig. B I. The light permeable material with a release layer stencil, a transparent metallized layer and, optionally, a clear print receptive layer, is a Part Processed Material for panels with a design to be seen through the light permeable material. The metallized layer acts as a barrier to solvent migration and, with or without the print receptive or other clear layer, provides protection to the release layer stencil in handling.

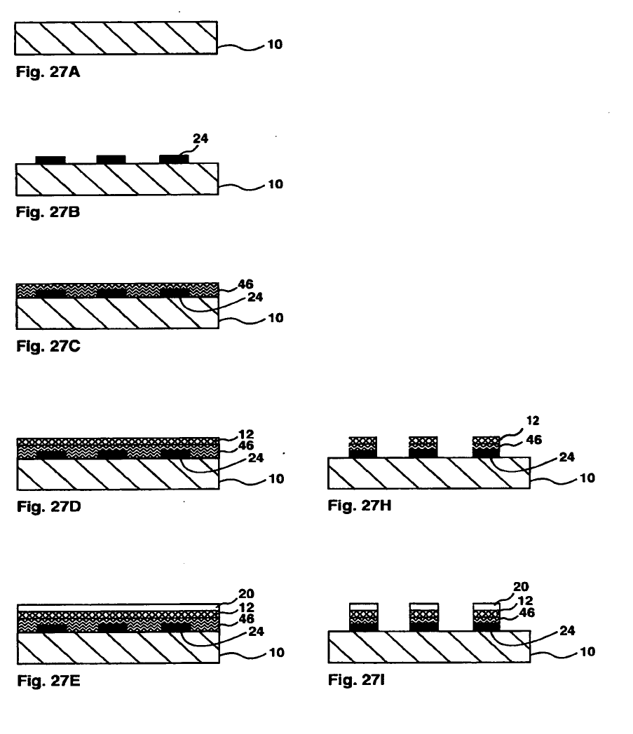

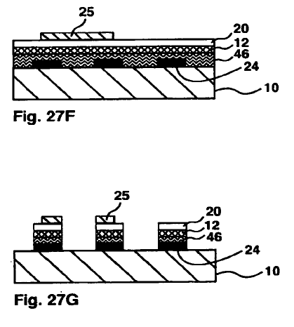

FIGS. 27A-I illustrate the production of panels using the fourth, “direct” method, for example by the application of mask layer 24 in the form of the desired print pattern onto the light permeable material 10, illustrated in FIG. 27B. In FIG. 27C, continuous release layer 46 adheres well to the mask layer 24 but not to the light permeable material 10. In FIG. 27D metallized layer 12 adheres well to the continuous release layer 46. White layer 20 is added, in FIG. 27E, to form an alternative “Part Processed Material”. Design 25 is applied to white layer 20, as illustrated in FIG. 27F, followed by the removal of unwanted marking material by means of an external force to leave the finished panel of FIG. 27G. Alternatively, the panel of FIG. 20D can have unwanted marking material removed outside the print pattern to leave a panel in which radiation—absorbing layer 24, typically black, is visible through the light permeable material 10 and metallic layer 12 is visible from the other side. Alternatively, mask layer 24 is a clear print-receptive material or a selectively applied print receptive process, for example a selectively applied corona treatment or other method of increasing surface energy, and the continuous release layer 46 is visible in the finished panel, for example black.

Unwanted marking material can be removed from the panel of FIG. 27E leaving a light-absorbing layer 24, typically black, visible through light permeable material 10 and a light reflective layer 20, typically white or a light color, visible from the other side of the panel, as shown in FIG. 27I. This product can form a “New Part Processed Material” with differential receptivity or adhesion to one or more imaging systems, as previously described.

The above embodiments are illustrative embodiments of the invention, which enable many other variants. For example, the anodized aluminum techniques of FIGS. 10A-12M, illustrated with the first “resist and etch” method, can be used with any of the second, third or fourth methods of the invention.

Because the edges of the layers in the printed portions of the print pattern are in substantially exact registration, products according to one or more embodiments of the invention automatically have a security printing characteristic, as substantially exact registration cannot be achieved by conventional printing methods. Moreover, one or more embodiments of the invention provide a more efficient and low cost means of achieving one, several, or all of the fifteen improvements to security printing, seals and labels disclosed in U.S. Pat. No. 4,925,705.

Panels according to one or more embodiments of this invention may be applied as labels, for example to bottles, or be laminated to a second substrate, for example to thicker plastic sheets or films, for example to form novelty playing cards or security cards such as credit cards. Transponder systems can utilize one or more embodiments of the invention, for example to produce see-through graphics antennae, for example on labels, for example incorporating a design superimposed on metallized antennae, for example using one of the demetallization processes outlined above in the conventional print pattern which can be described as a rectilinear spiral.

One or more embodiments of the invention provides a more economic means of producing panels according to US RE37,186 with substantially exact registration of the superimposed layers within the silhouette pattern than those methods disclosed in that patent or subsequently developed conventional methods.

Overlamination, by the use of clear, self-adhesive film or heat-activated film overlaminates, has been found to be impractical with various conventional partially printed panels having relatively thick layers of ink, as the thickness of ink results in air inclusions adjacent to ink edges, causing optical distortion of through vision and potential initiation of delamination. Even with liquid lamination, optical distortion results from the surface topography of the curved liquid which “reflects” the thick ink deposit thickness, having a lens effect rather than the plane surface required for good through vision. The relatively much thinner layers used in one or more embodiments of the present invention allow lamination liquids, pressure-sensitive and heat-activated adhesives to accommodate the ink surface topography.

This increases these products' abrasion resistance, which is of particular value in “semi-permanent” applications such as building partitions and squash court walls, existing applications for one-way and other vision control panels which have previously been prejudiced by the ink layers being exposed to cleaning and other types of abrasions.

One or more embodiments of the present invention provides a metallized layer forming one of a plurality of layers of marking material on one side of a see-through graphic panel. One or more embodiments of the present invention provides methods 3 and 4 of demetallization using an external force for any kind of product.

A metallized layer according to one or more embodiments of the present invention has several advantages, including:
(i) it provides a visually distinct and more attractive layer, if exposed, than various conventional metallic inks.
(ii) it provides a more efficient opacity transition layer, for example between white and black layers, than various conventional metallic inks.
(iii) it is a substantially thinner and easier to remove than various conventional metallic inks and it enables the other layers of marking material to be thinner and therefore:
   (a) less ink is used, and
   (b) unwanted ink is easier and cheaper to remove, and
   (c) it is easier to overlaminate and provides improved optical performance following overlamination, for example by self-adhesive overlaminate film, heat-activated adhesive overlaminate film or liquid overlaminate.
(iv) it enables the use of a much thinner stencil than various conventional methods, as a thick edge to the stencil is not needed to initiate an ink fracture mechanism. This in turn enables more efficient methods of printing a stencil, for example roll to roll gravure, which in turn enables a continuous metallized deposit above it, unlike one or more conventional stencils which cause discontinuities in a superimposed metallized layer. These multiple, mutually enabling benefits of reduced thickness of all the layers make conversion of a Part Processed Material by a Design Printer, who applies a design to the Part Processed Material and then removes the unwanted marking material, much easier.
(v) it acts as a barrier layer to the migration of liquids, for example solvents, that have several potentially deleterious affects on the layers below, for example:
   (a) making the ink layer or layers below less brittle and, consequently, subsequent ink removal more difficult by methods 3 or 4, which require an ink fracture mechanism.
   (b) reactivating solvents or other ink components in layers below or otherwise causing ink interaction and a ghosted image of a design from the other side of the panel.
   (c) damaging the light permeable material and/or adhesive below.
   (d) attacking and causing voids in the water-activated stencil of method 2, or the release layer stencil of method 3 or the mask of method 4, for example causing ink or other marking material to remain outside the desired print pattern, for example reducing the quality of through vision in a one-way vision panel.

The foregoing description is included to illustrate the operation of the preferred embodiments and is not meant to limit the scope of the invention. To the contrary, those skilled in the art should appreciate that varieties may be constructed and employed without departing from the scope of the invention, aspects of which are recited by the claims appended hereto.

We claim:

1. A panel comprising:
a sheet of imperforate light permeable material; and
a print pattern comprising a plurality of layers of marking material adhered to said light permeable material, said print pattern dividing said panel into a plurality of discrete areas of said marking material and/or a plurality of discrete areas devoid of said marking material; and
a metallized layer,
wherein part of said print pattern when viewed from one side of the panel is of a different color than part of said print pattern when viewed from the other side of the panel, and
wherein a part of the boundary of one layer of said marking material is in substantially exact registration with a part of the boundary of another of said layers of marking material.

2. A panel as claimed in claim 1, wherein one of said layers of marking material is said metallized layer.

3. A panel as claimed in claim 2, wherein one of said layers of marking material comprises a radiation-absorbing layer, and wherein said metallized layer is adjacent to said radiation-absorbing layer.

4. A panel as claimed in claim 3, wherein said radiation-absorbing layer is black.

5. A panel as claimed in claim 3, wherein one of said layers of marking material comprises a radiation-reflecting layer, and wherein said metallized layer is adjacent to said radiation-reflecting layer.

6. A panel as claimed in claim 5, wherein said radiation-reflecting layer is white.

7. A panel as claimed in claim 5, wherein one of said layers of marking material comprises a radiation-absorbing layer, and wherein said metallized layer is intermediate said radiation-absorbing layer and said radiation-reflecting layer.

8. A panel as claimed in claim 7, wherein said radiation-absorbing layer is black and said radiation-reflecting layer is white.

9. A panel as claimed in claim 1, wherein said light permeable material is transparent.

10. A panel as claimed in claim 1, wherein said light permeable material is translucent.

11. A panel as claimed in claim 1, wherein one of said layers of marking material is a design layer comprising a design color layer.

12. A panel as claimed in claim 11, wherein said design color layer extends over only a part of said print pattern.

13. A panel as claimed in claim 8, wherein one of said layers of marking material comprises a design layer that is adjacent to said white layer.

14. A panel as claimed in claim 13, wherein said light permeable material is transparent, and wherein said design layer is reverse printed directly onto said transparent material and is visible through said transparent material.

15. A panel as claimed in claim 13, wherein said light permeable material is transparent, and wherein said black layer is adjacent to said transparent material.

16. A panel as claimed in claim 14, wherein said light permeable material is transparent, and wherein said black layer is remote from said transparent material.

17. A panel as claimed in claim 1, wherein said plurality of layers of marking material comprise:
a radiation-absorbing layer;
a radiation reflecting layer; and
a metallic ink layer intermediate said radiation-absorbing layer and said radiation reflecting layer.

18. A panel as claimed in claim 1, wherein said metallized layer comprises vacuum metallized aluminum.

19. A panel as claimed in claim 1, wherein a thickness of said plurality of layers of marking material is less than 20 micron.

20. A panel as claimed in claim 19, wherein the thickness of said plurality of layers of marking material is less than 15 micron.

21. A method of making a panel comprising a sheet of imperforate light permeable material and a print pattern comprising a plurality of layers of marking material adhered to said light permeable material, said print pattern dividing said panel into a plurality of discrete areas of said marking material and/or a plurality of discrete areas devoid of said marking material, said panel comprising a metallized layer, wherein part of said print pattern when viewed from one side of the panel is of a different color to part of said print pattern when viewed from the other side of the panel, and wherein a part of the boundary of one layer of said marking material is in substantially exact registration with a part of the boundary of another of said layers of marking material, said method including the steps of:
(i) applying a mask to said one side of said light permeable material to define said print pattern;
(ii) applying layers of marking material to said one side of said light permeable material, one of the layers being a metallized layer; and
(iii) removing a plurality of unwanted layers of said marking material from outside said print pattern, to leave a part of the boundary of one of said layers of marking material in substantially exact registration with a part of the boundary of another of said layers of marking material.

22. A method of making a panel as claimed in claim 21, wherein one of said layers of marking material is said metallized layer.

23. A method of making a panel as claimed in claim 22, wherein one of said layers of marking material comprises a radiation-absorbing layer, and wherein said metallized layer is adjacent to said radiation-absorbing layer.

24. A method of making a panel as claimed in claim 23, wherein said radiation-absorbing layer is black.

25. A method of making a panel as claimed in claim 23, wherein one of said layers of marking material comprises a radiation-reflecting layer, and wherein said metallized layer is adjacent to said radiation-reflecting layer.

26. A method of making a panel as claimed in claim 25, wherein said radiation-reflecting layer is white.

27. A method of making a panel as claimed in claim 23, wherein said layers of marking material comprise a radiation-absorbing layer and a radiation-reflecting layer, and wherein said metallized layer is intermediate said radiation-absorbing layer and said radiation-reflecting layer.

28. A method of making a panel as claimed in claim 27, wherein said radiation-absorbing layer is black and said radiation-reflecting layer is white.

29. A method of making a panel as claimed in claim 21, wherein said light permeable material is transparent.

30. A method of making a panel as claimed in claim 21, wherein said light permeable material is translucent.

31. A method of making a panel as claimed in claim 21, wherein one of said layers of marking material is a design layer comprising a design color layer.

32. A method of making a panel as claimed in claim 31, wherein said design color layer extends over only a part of said print pattern.

33. A method of making a panel as claimed in claim 28, wherein one of said layers of marking material comprises a design layer that is adjacent to said white layer.

34. A method of making a panel as claimed in claim 33, wherein said light permeable material is transparent, and wherein said design layer is reverse printed directly onto said transparent material and is visible through said transparent material.

35. A method of making a panel as claimed in claim 33, wherein said light permeable material is transparent, and wherein said black layer is printed directly onto said transparent material.

36. A method of making a panel as claimed in claim 34, wherein said light permeable material is transparent, and wherein said black layer is remote from said transparent material.

37. A method of making a panel as claimed in claim 35, wherein said white layer is receptive to an imaging system used to print a design layer onto said white layer.

38. A method of making a panel as claimed in claim 37, wherein said imaging system is a digital inkjet printer.

39. A method of making a panel as claimed in claim 21, wherein said layers of marking material comprise:
a radiation-absorbing layer,
a radiation reflecting layer; and
a metallic ink layer intermediate said radiation-absorbing layer and said radiation reflecting layer.

40. A method of making a panel as claimed in claim 21, wherein said metallized layer comprises vacuum metallized aluminum.

41. A method of making a panel as claimed in claim 21, wherein said mask is a resist layer in the form of said print pattern, and wherein removing the plurality of unwanted layers comprises removing said unwanted layers of said marking material by solvent etch.

42. A method of making a panel as claimed in claim 21, wherein said mask is a water-activated stencil of said print pattern applied directly to said light permeable material, and wherein removing the plurality of unwanted layers comprises applying water to said unwanted layers of said marking material.

43. A method of making a panel as claimed in claim 21, wherein said mask is a release layer stencil of said print pattern applied directly to said light permeable material, and wherein removing the plurality of unwanted layers comprises applying an external force.

44. A method of making a panel as claimed in claim 43, wherein said release layer stencil is removed with said unwanted layers of said marking material.

45. A method of making a panel as claimed in claim 43, wherein said release layer stencil is not removed from said light permeable material.

46. A method of making a panel as claimed in claim 43, wherein said external force is applied by the application and removal of an adhering layer.

47. A method of making a panel as claimed in claim 46, wherein said adhering layer comprises a self-adhesive film.

48. A method of making a panel as claimed in claim 43, wherein said external force comprises jetting with one of water, air, and an abrading medium comprising solid particles.

49. A method of making a panel as claimed in claim 21, wherein said mask is a first layer of said layers of marking material in the form of said print pattern applied directly to said light permeable material, and wherein removing the plurality of unwanted layers comprises applying an external force.

50. A method of making a panel as claimed in claim 49, wherein said release layer stencil is removed with said unwanted layers of said marking material.

51. A method of making a panel as claimed in claim 49, wherein said release layer stencil is not removed from said light permeable material.

52. A method of making a panel as claimed in claim 49, wherein said external force is applied by the application and removal of an adhering layer.

53. A method of making a panel as claimed in claim 49, wherein said adhering layer comprises a self-adhesive film.

54. A method of making a panel as claimed in claim 49, wherein said external force comprises jetting with one of water, air, and an abrading medium comprising solid particles.

55. A method as claimed in claim 21, where a thickness of said plurality of layers of marking material is less than 20 microns.

56. A method as claimed in claim 55, where the thickness of said plurality of layers of marking material is less than 15 microns.

57. A method as claimed in claim 56, where the thickness of said plurality of layers of marking material is less than 10 microns.
